(19) United States
(12) Patent Application Publication
(10) Pub. No.: US 2026/0341555 A1
(43) Pub. Date: Oct. 29, 2026

(54) PROCESSING DEVICE FOR MULTI-CORE SHIELDED CABLE

(71) Applicant: Shinmaywa Industries, Ltd., Takarazuka-shi, Hyogo (JP)

(72) Inventors: Hiroaki SHIRAI, Takarazuka-shi (JP); Yoshiki TAKAHASHI, Takarazuka-shi (JP); Morihiro OKADA, Takarazuka-shi (JP)

(21) Appl. No.: 19/114,509

(22) PCT Filed: Oct. 11, 2023
(86) PCT No.: PCT/JP2023/036891

§ 371 Date: Mar. 24, 2025

(30) Foreign Application Priority Data
Oct. 14, 2022 (JP) 2022-165888

(51) Int. Cl. H01B 13/22

(52) U.S. Cl. CPC H01B 13/22

(57) ABSTRACT

A processing device 10 for a multi-core shielded cable 1 includes a first-step processing device 10A that strips a sheath 2, a detection device 140 that detects the position of a drain wire 3 in the circumferential direction, a second-step processing device 10B that processes the tip portions of electric wires 3 and 4, a relay device 150 that relays the multi-core shielded cable 1 between the first-step processing device 10A and the second-step processing device 10B, a positioning device 100, and a controller 200. The positioning device 100 includes a first gripping device 160R that grips the multi-core shielded cable 1, and a first rotating device 170R that rotates the multi-core shielded cable 1 gripped by the first gripping device 160R. The controller 200 controls the positioning device 100 based on the detection results from the detection device 140 to drive at least the first rotating device 170R and to thereby move the drain wire 3 to a predetermined position in the circumferential direction.

### TECHNICAL FIELD

The present invention relates to a processing device for a multi-core shielded cable.

### BACKGROUND ART

Methods for processing drain wires of multi-core shielded cables having drain wires have been proposed in the art. For example, PTL 1 discloses a process of crimping a terminal to a drain wire that has been pulled out of the sheath and folded in half.

PTL 2 discloses a manufacturing device that performs, in this order for a multi-core cable (twisted cable) having a sheath: a sheath stripping step; an untwisting step of untwisting core wires; a direction adjusting and unkinking step of unkinking the kinks in the core wires; a core wire length adjusting step; a core wire sheath stripping step; and a terminal connecting step. The manufacturing device disclosed in PLT 2 includes a plurality of fixed chucks that are arranged along the conveying path of the multi-core cable to hold the multi-core cable, and a movable chuck that holds the multi-core cable and reciprocates between the fixed chucks. The multi-core cable is conveyed through the plurality of fixed chucks from one to another by the movable chuck while being curved in a U-letter shape. The multi-core cable is thus conveyed between the steps.

### CITATION LIST

### Patent Literature

PTL 1: JP 2007-207738 A
PTL 1: JP 2019-179675 A

### SUMMARY OF INVENTION

### Technical Problem

Of the processes performed for a multi-core shielded cable having a drain wire and a plurality of core wires covered by a sheath, in the step of processing the tip portion such as crimping a terminal to the drain wire and the core wires, for example, electric wires are processed individually. Therefore, it is preferred that the drain wire and the core wires are individually recognized before the tip portion processing step. Since the processing for the drain wire and the processing for the core wires are often different, it is necessary that at least the drain wire and the core wires are recognized distinctively.

The present invention has been made in view of the above, and an object thereof is to provide a processing device for a multi-core shielded cable that is configured to distinguish between the drain wire and the core wires before processing the tip portion, and to provide a processing device for a multi-core shielded cable that is made more efficient as a device.

### Solution to Problem

A processing device for a multi-core shielded cable according to the present invention includes: a first-step processing device that at least performs sheath stripping for a multi-core shielded cable including a drain wire, one or more core wire, and a sheath covering the drain wire and the core wire; a detection device that detects a position of the drain wire for a circumferential direction of the multi-core shielded cable; a second-step processing device arranged side by side with the first-step processing device in a predetermined conveying direction, wherein the second-step processing device performs processing of a tip portion for at least one of the drain wire and the core wire; a positioning device; a relay device that receives the multi-core shielded cable from the first-step processing device and hands over the multi-core shielded cable to the second-step processing device; and a controller. The positioning device includes a first gripping device that grips the multi-core shielded cable so that a longitudinal direction thereof coincides with an orthogonal direction, which is orthogonal to the conveying direction, and a first rotating device that rotates the multi-core shielded cable gripped by the first gripping device around a first rotation shaft extending in the orthogonal direction. The controller controls the positioning device based on detection results from the detection device to drive at least the first rotating device and to thereby move the drain wire to a predetermined position around the first rotation shaft.

With the processing device for a multi-core shielded cable described above, the multi-core shielded cable is rotated so that the drain wire moves to a predetermined position. Based on the position of the drain wire after being moved, it is possible to distinguish the drain wire from the core wires. In the processing by the second-step processing device, such as stripping or crimping, the process conditions may be made different for the drain wire and for the core wires, and distinguishing between the drain wire and the core wires makes it easier to set the process conditions. Thus, it is possible to make more efficient the processing device for a multi-core shielded cable.

In one preferred embodiment of the processing device for a multi-core shielded cable according to the present invention, the first rotating device rotates the multi-core shielded cable so that the drain wire moves to a most upstream position or a most downstream position in the conveying direction among the drain wire and the core wire.

With the processing device for a multi-core shielded cable described above, since the drain wire is located at one end in the conveying direction in the second-step processing device, the processing of the drain wire is the first or last among the drain wire and the core wires. Therefore, where the processing for the drain wire and the processing for the core wires are different, the number of setup changes can be minimized.

In one preferred embodiment of the processing device for a multi-core shielded cable according to the present invention, the positioning device includes: a second gripping device provided in the first-step processing device that grips the multi-core shielded cable so that the longitudinal direction thereof coincides with the orthogonal direction; and a second rotating device that rotates the multi-core shielded cable gripped by the second gripping device around a second rotation shaft extending in the orthogonal direction. The detection device is configured to detect a position of the drain wire for the circumferential direction of the multi-core shielded cable while the multi-core shielded cable is gripped by the second gripping device. The controller controls the second rotating device based on detection by the detection device to rotate the multi-core shielded cable so that the drain wire faces toward the detection device, and then controls the first rotating device to move the drain wire to the predetermined position.

With the processing device for a multi-core shielded cable described above, the position of the drain wire for the circumferential direction of the multi-core shielded cable while being gripped by the second gripping device of the first-step processing device (hereinafter, also referred to simply as the position of the drain wire in the circumferential direction) is detected by the detection device, and the position of the drain wire in the circumferential direction is set to a position that faces toward the detection device. This determines the position of the drain wire in the circumferential direction, and therefore makes easier the processing of the drain wire and the core wires in the first-step processing device. In the first-step processing device, the position of the drain wire in the circumferential direction is set to a position that faces toward the detection device, thus enabling accurate positioning of the drain wire. Since the drain wire can be accurately positioned in the first-step processing device, positioning of the drain wire by the first gripping device and the first rotating device can also be done more accurately.

In one preferred embodiment of the processing device for a multi-core shielded cable, the first-step processing device includes a tube attaching device that attaches a heat-shrink tube to the drain wire, which has been moved so as to face toward the detection device.

With the processing device for a multi-core shielded cable described above, the position of the drain wire in the circumferential direction is determined by the action of the second rotating device, and it is therefore possible to easily attach the heat-shrink tube.

In one preferred embodiment of the processing device for a multi-core shielded cable according to the present invention, the first-step processing device includes a bending device that bends the multi-core shielded cable into a U-letter shape so that opposite end portions thereof are arranged side by side in the conveying direction. The bending device forms, in the multi-core shielded cable, an upstream-side portion extending in the orthogonal direction, a downstream-side portion extending in the orthogonal direction and located downstream of the upstream-side portion in the conveying direction, and a bent portion located between the upstream-side portion and the downstream-side portion. The detection device detects a position of the drain wire on an upstream side for the circumferential direction of the upstream-side portion, and a position of the drain wire on a downstream side for the circumferential direction of the downstream-side portion. The first gripping device is configured to grip the upstream-side portion of the multi-core shielded cable. The first rotating device is configured to rotate the upstream-side portion of the multi-core shielded cable. The positioning device includes: a downstream-side first gripping device provided on a downstream side in the conveying direction relative to the first gripping device to grip the downstream-side portion of the multi-core shielded cable; and a downstream-side first rotating device that rotates the downstream-side portion gripped by the downstream-side first gripping device around another first rotation shaft extending in the orthogonal direction. The controller controls the downstream-side first rotating device to move the drain wire on the downstream side to a predetermined position around the other first rotation shaft.

With the processing device for a multi-core shielded cable described above, the position of the drain wire can be determined at the opposite end portions of the multi-core shielded cable, which is bent in a U-letter shape, to successively process the opposite end portions. Therefore, the drain wire and the core wires can be distinguished from each other at both ends of the multi-core shielded cable.

In one preferred embodiment of the processing device for a multi-core shielded cable, the first rotation shaft is provided so as to be off a line extending along an axis of the upstream-side portion while the first gripping device is gripping the upstream-side portion of the multi-core shielded cable. The first rotating device is configured to rotate the first gripping device around the first rotation shaft, and rotates the first gripping device so that the line extending along the axis of the upstream-side portion moves downstream in the conveying direction.

With the processing device for a multi-core shielded cable described above, the opposite ends of the multi-core shielded cable move closer to each other in the conveying direction, and the distance between the opposite ends becomes narrower. Therefore, it is possible to shorten the length of the second-step processing device in the conveying direction.

In one preferred embodiment of the processing device for a multi-core shielded cable, the other first rotation shaft is provided so as to be off a line extending along an axis of the downstream-side portion while the downstream-side first gripping device is gripping the downstream-side portion of the multi-core shielded cable. The downstream-side first rotating device is configured to rotate the downstream-side first gripping device around the other first rotation shaft, and rotates the downstream-side first gripping device so that the line extending along the axis of the downstream-side portion moves upstream in the conveying direction.

Also with the processing device for a multi-core shielded cable described above, the opposite ends of the multi-core shielded cable move closer to each other in the conveying direction, and the distance between the opposite ends becomes narrower. Therefore, it is possible to shorten the length of the second-step processing device in the conveying direction.

A processing device for a multi-core shielded cable according to one preferred embodiment of the present invention further includes: an upstream-side third gripping device that is provided side by side with the first gripping device in the orthogonal direction, and grips the upstream-side portion of the multi-core shielded cable; a downstream-side third gripping device that is provided side by side with the downstream-side first gripping device in the orthogonal direction, and grips the downstream-side portion of the multi-core shielded cable; and a first moving device. The first moving device moves at least one of a pair of third gripping devices including the upstream-side third gripping device and the downstream-side third gripping device and a pair of first gripping devices including the first gripping device and the downstream-side first gripping device in the orthogonal direction to thereby move the pair of third gripping devices relative to the pair of first gripping devices in the orthogonal direction. The controller is configured to be capable of controlling the bending device so that a position of an upstream tip of the multi-core shielded cable and a position of a downstream tip of the multi-core shielded cable are shifted from each other by a predetermined distance in the orthogonal direction. Where the position of the upstream tip of the multi-core shielded cable and the position of the downstream tip of the multi-core shielded cable are shifted from each other by the predetermined distance, the controller is configured to: (1) control one of the first gripping device and the downstream-side first gripping device to grip the multi-core shielded cable, and control the other to release the multi-core shielded cable; (2) control the third gripping device, among the upstream-side third gripping device and the downstream-side third gripping device, corresponding to the first gripping device that has released the multi-core shielded cable to grip the multi-core shielded cable, and control the third gripping device corresponding to the first gripping device that is gripping the multi-core shielded cable to release the multi-core shielded cable; and (3) further control the first moving device to move the pair of third gripping devices relative to the pair of first gripping devices by the predetermined distance in the orthogonal direction so as to align a position of the upstream tip of the multi-core shielded cable in the orthogonal direction with a position of the downstream tip of the multi-core shielded cable in the orthogonal direction.

With the processing device for a multi-core shielded cable described above, even if the position of the upstream tip and the position of the downstream tip are shifted from each other when the multi-core shielded cable is bent, it is possible to align the position of the upstream tip with the position of the downstream tip. Therefore, it is easier to perform processing of the tip portion by the second-step processing device.

In one preferred embodiment of the processing device for a multi-core shielded cable according to the present invention, the first gripping device is provided in the relay device. The relay device uses the first gripping device to receive the multi-core shielded cable from the first-step processing device, and hand over the multi-core shielded cable to the second-step processing device.

With the processing device for a multi-core shielded cable described above, the positioning device and the relay device are partially shared. This allows the processing device for a multi-core shielded cable to be made more compact.

In one preferred embodiment of the processing device for a multi-core shielded cable according to the present invention, the relay device further includes a second moving device that moves the first gripping device between an upstream-side relay position, at which the multi-core shielded cable is relayed between the first-step processing device and the first gripping device, and a downstream-side relay position, at which the multi-core shielded cable is relayed between the first gripping device and the second-step processing device. The controller controls the second moving device to move the first gripping device from the upstream-side relay position to the downstream-side relay position, and controls the first rotating device to move the drain wire to the predetermined position while the first gripping device is moved from the upstream-side relay position to the downstream-side relay position.

With the processing device for a multi-core shielded cable described above, it is possible to position the drain wire in the circumferential direction while moving the multi-core shielded cable in the conveying direction. Thus, it is possible to shorten the cycle time for processing the multi-core shielded cable.

In one preferred embodiment of the processing device for a multi-core shielded cable according to the present invention, the controller controls the first rotating device based on detection by the detection device to rotate the multi-core shielded cable so that the drain wire faces toward the detection device, and then move the drain wire to the predetermined position.

With the processing device for a multi-core shielded cable described above, preliminary positioning of the drain wire is performed so that the position of the drain wire in the circumferential direction is set to a position that faces toward the detection device. This preliminary positioning of the drain wire may be performed accurately because the position of the drain wire in the circumferential direction is a position that faces toward the detection device. Since the preliminary positioning of the drain wire has been performed accurately, the positioning of the drain wire thereafter can also be performed more accurately.

### Effects of Invention

According to the present invention, it is possible to make more efficient a processing device for a multi-core shielded cable configured to distinguish between the drain wire and the core wires before processing the tip portion.

### BRIEF DESCRIPTION OF DRAWINGS

FIG. 1 A schematic cross-sectional view of a multi-core shielded cable.

FIG. 2 A schematic plan view of a multi-core shielded cable processing device according to one embodiment.

FIG. 3 A schematic plan view of a core wire separation device.

FIG. 4 A schematic rear view of the core wire separation device.

FIG. 5 A perspective view of a fixed clamp forward of the core wire separation device and a detection device.

FIG. 6 A perspective view of a relay device.

FIG. 7 A rear view of the relay device.

FIG. 8 A rear view of the relay device after an upstream-side clamp and a downstream-side clamp have been rotated.

FIG. 9 A perspective view of the relay device after the upstream-side clamp and the downstream-side clamp have been rotated and moved laterally.

FIG. 10 A block diagram of the multi-core shielded cable processing device.

FIG. 11A The first half of a flow chart showing the processing of the multi-core shielded cable.

FIG. 11B The second half of the flow chart showing the processing of the multi-core shielded cable.

FIG. 12 A perspective view showing the relay device gripping the multi-core shielded cable where the tip positions of the opposite end portions are different from each other.

FIG. 13 A perspective view showing the relay device immediately after starting the work of aligning the tip positions of the opposite end portions.

FIG. 14 A perspective view showing the relay device after finishing aligning the tip positions of the opposite end portions.

### DESCRIPTION OF EMBODIMENTS

### Configuration of Processing Device

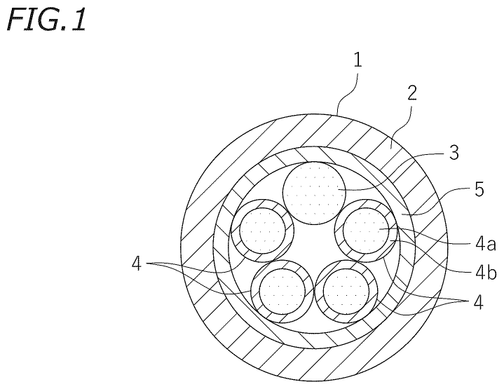

An embodiment of the present invention will now be described with reference to the drawings. First, a multi-core shielded cable 1, which is the subject of wire processing described here, will be described with reference to FIG. 1. FIG. 1 is a schematic cross-sectional view of the multi-core shielded cable 1 according to one example. As shown in FIG. 1, the multi-core shielded cable 1 includes a sheath 2, a drain wire 3, a plurality of core wires 4, and a shield 5. The sheath 2 is made of an insulator, and covers the drain wire 3, the plurality of core wires 4, and the shield 5. The plurality of core wires 4 are used as signal wires to transmit electrical signals, for example. The plurality of core wires 4 each include a core 4a and a cover 4b that is an insulator covering the core 4a. The shield 5 is a conductor that shields the core wires 4 from external noise. The shield 5 covers the outside of the plurality of core wires 4. The drain wire 3 is electrically connected to the shield 5. The drain wire 3 is grounded, thereby grounding the shield 5. The drain wire 3 includes a plurality of thin conductor strands, and is not sheathed by an insulator. Although not shown in the figures, the drain wire 3 and the plurality of core wires 4 are twisted together inside the shield 5. There is no particular limitation on the number of core wires 4. The number of core wires 4 may be one or more. In the following, when the drain wire 3 and the plurality of core wires 4 are not particularly distinguished from each other, they may be referred to collectively as “electric wires”.

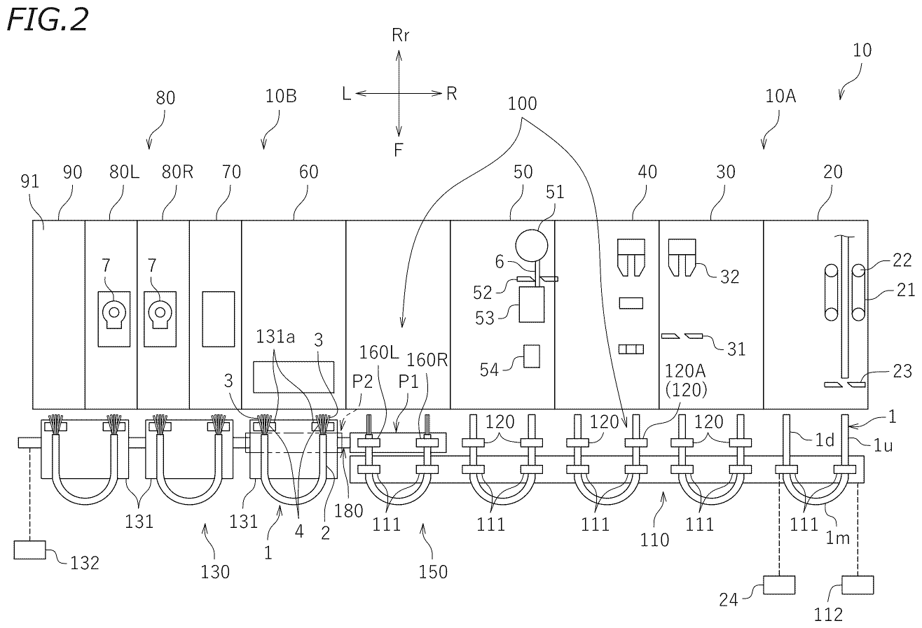

FIG. 2 is a schematic plan view of a processing device for the multi-core shielded cable 1 according to one embodiment (hereinafter simply referred to as the “processing device” 10). The processing device 10 is a device for insulating the drain wire 3 and crimps a terminal 7 to the tip thereof, and also crimps a terminal 7 to the tip of each of the plurality of core wires 4. The insulating process for the drain wire 3 is a process of wrapping the drain wire 3 with a heat-shrink tube 6, and heat shrinking the heat-shrink tube 6. The processing device 10 may be configured to further perform a process of attaching waterproofing rubber plugs to the drain wire 3 and the plurality of core wires 4.

Hereinafter, the downward side in FIG. 2 of where the conveying path of the multi-core shielded cable 1 is formed will be referred to as the forward side of the processing device 10. Leftward and rightward of the processing device 10 will be referred to as leftward and rightward when viewed from the forward side of the processing device 10 toward the rearward side. In the figures, front, rear, left, right, up, and down will be denoted by reference signs F, Rr, L, R, U, and D, respectively. Note however that these directions are merely defined for the sake of explanation and do not in any way limit how the processing device 10 is installed, etc.

As shown in FIG. 2, the processing device 10 according to a present embodiment includes a first-step processing device 10A that performs at least stripping the sheath 2 of the multi-core shielded cable 1, and a second-step processing device 10B that performs processing of the tip portion of at least one of the drain wire 3 and the plurality of core wires 4. Some of the drain wire 3 and the plurality of core wires 4 may not require processing of the tip portion by the second-step processing device 10B. The second-step processing device 10B is arranged side by side with the first-step processing device 10A in the conveying direction of the multi-core shielded cable 1 (here, the left-right direction). Specifically, the second-step processing device 10B is arranged downstream (here, leftward) of the first-step processing device 10A in the conveying direction of the multi-core shielded cable 1. In the present embodiment, the first-step processing device 10A is configured to grip the portion of the multi-core shielded cable 1 covered by the sheath 2, and the second-step processing device 10B is configured to individually grip the drain wire 3 and the plurality of core wires 4. In the present embodiment, the first-step processing device 10A and the second-step processing device 10B are separated because they use different gripping methods. Therefore, the processing device 10 according to the present embodiment further includes a relay device 150 that receives the multi-core shielded cable 1 from the first-step processing device 10A and hands over the multi-core shielded cable 1 to the second-step processing device 10B.

In the present embodiment, the first-step processing device 10A includes a cut-and-shape device 20 that cuts the multi-core shielded cable 1 to a predetermined length and bends it into a U-letter shape, a semi-stripping device 30 that performs a semi-stripping step of slitting the sheath 2 and pulling out the sheath 2 halfway, a core wire separation device 40 that completely pulls out the sheath 2 on the tip side and separates the drain wire 3 and the plurality of core wires 4, and a tube attaching device 50 that attaches the heat-shrink tube 6 to the drain wire 3. Note however that the devices included in the first-step processing device 10A and the steps carried out by the first-step processing device 10A are merely one preferred example, and there is no particular limitation thereto. These devices are arranged side by side in this order towards the downstream side in the conveying direction of the multi-core shielded cable 1.

As shown in FIG. 2, the first-step processing device 10A includes a conveying device 110 that conveys the multi-core shielded cable 1 from the cut-and-shape device 20 to the tube attaching device 50. The conveying device 110 includes a plurality of conveying clamps 111 arranged side by side in the conveying direction of the multi-core shielded cable 1, a driving section 112 that moves the plurality of conveying clamps 111 in the conveying direction, and a plurality of fixed clamps 120 arranged side by side in the front-rear direction (a direction that is orthogonal to the conveying direction, hereinafter referred to also as the orthogonal direction) relative to the devices of the first-step processing device 10A. The plurality of conveying clamps 111 and the plurality of fixed clamps 120 grip the multi-core shielded cable 1 (specifically, the straight portion on the upstream side or the downstream side) so that the longitudinal direction of the multi-core shielded cable 1 (here, the longitudinal direction of the opposing straight portions bent in a U-letter shape) coincides with the orthogonal direction (the front-rear direction). The conveying clamps 111 convey the multi-core shielded cable 1 between the plurality of fixed clamps 120. Thus, a plurality of multi-core shielded cables 1 are successively conveyed downstream in the conveying direction. Note that the number of conveying clamps 111 may be one, rather than plural.

The second-step processing device 10B includes an alignment device 60 that individually grips the drain wire 3 and the plurality of core wires 4 to align them at the same pitch, a stripping device 70 that strips the heat-shrink tube 6 covering the drain wire 3 and the cover 4b of the plurality of core wires 4, a crimping device 80 that crimps the terminals 7 to the drain wire 3 and the plurality of core wires 4, and an ejecting device 90 that ejects the multi-core shielded cable 1.

As shown in FIG. 2, the second-step processing device 10B includes a shuttle conveying device 130 that conveys the multi-core shielded cable 1 from the alignment device 60 to the ejecting device 90. The shuttle conveying device 130 includes a plurality of shuttles 131 each including gripping portions 131a for individually gripping the drain wire 3 and the plurality of core wires 4, and a driving section 132 that circulates the plurality of shuttles 131. Note that the number of shuttles 131 may be one rather than plural. The shuttles 131 may be reciprocated rather than circulated.

The configuration of the devices of the first-step processing device 10A, the devices of the second-step processing device 10B, and the relay device 150 will be described below. The cut-and-shape device 20 of the first-step processing device 10A cuts the multi-core shielded cable 1 to a predetermined length and shapes it into a U-letter shape. The cut-and-shape device 20 includes a feeding device 21 that conveys the multi-core shielded cable 1, the length measuring device 22 that measures the length of the multi-core shielded cable 1, a cutting device 23 that cuts the multi-core shielded cable 1 to a predetermined length, and a bending device 24 that bends the multi-core shielded cable 1, which has been cut, into a U-letter shape. The bending device 24 bends the multi-core shielded cable 1 into a U-letter shape so that the opposite end portions are arranged side by side in the conveying direction. The bending device 24 thus forms, in the multi-core shielded cable 1, an upstream-side portion 1u extending in the orthogonal direction, a downstream-side portion 1d extending in the orthogonal direction and located downstream of the upstream-side portion 1u in the conveying direction, and a bent portion 1m located between the upstream-side portion 1u and the downstream-side portion 1d. The tip portion (the open end) of the upstream-side portion 1u will be referred to also as the upstream-side end portion of the multi-core shielded cable 1, and the tip portion of the downstream-side portion 1d will be referred to also as the downstream-side end portion of the multi-core shielded cable 1. The sheath 2 is stripped from the upstream-side end portion and the downstream-side end portion of the multi-core shielded cable 1, and the terminals 7 are crimped to the drain wire 3 and the core wires 4, which are exposed by the sheath stripping.

Here, the bending device 24 includes an arc-shaped rail (not shown) for moving the second most upstream conveying clamp 111 in the conveying direction to a position forward of the most upstream conveying clamp 111 in the conveying direction, and a driving section (denoted in FIG. 2 by reference sign 24 of the bending device) for moving the second most upstream conveying clamp 111 in the conveying direction along the rail. With the second most upstream conveying clamp 111 being arranged forward of the most upstream conveying clamp 111, the multi-core shielded cable 1 before being bent is gripped, and then the second conveying clamp 111 is moved toward the downstream side in the conveying direction of the most upstream conveying clamp 111, thereby moving the multi-core shielded cable 1 into a U-letter shape. After the multi-core shielded cable 1 is shaped in a U-letter shape, the most upstream conveying clamp 111 grips the upstream-side portion 1u of the multi-core shielded cable 1. The second most upstream conveying clamp 111 grips the downstream-side portion 1d of the multi-core shielded cable 1.

The semi-stripping device 30 includes a slitting device 31 that slits the sheath 2, and a pull-out device 32 for pulling out the sheath 2 halfway. In the semi-stripping step, the pull-out device 32 moves the distal-side sheath 2 toward the tip side of the multi-core shielded cable 1 while rotating the sheath 2 in the circumference direction relative to the proximal-side the sheath 2. The pull-out device 32 thus untwists the drain wire 3 and the plurality of core wires 4.

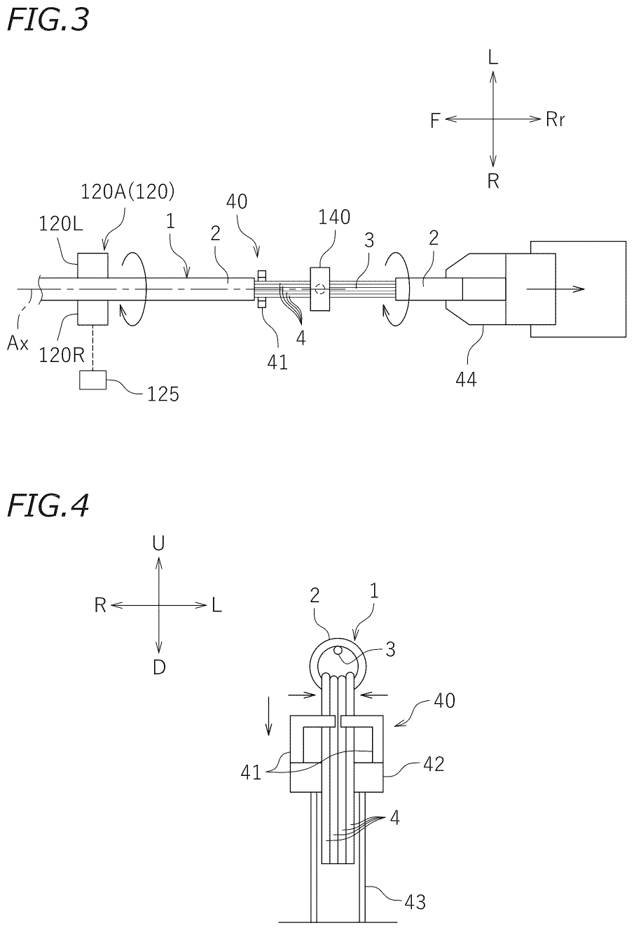

The core wire separation device 40 separates the plurality of core wires 4 from the drain wire 3 by bending the plurality of core wires 4. FIG. 3 is a schematic plan view of the core wire separation device 40. FIG. 4 is a schematic rear view of the core wire separation device 40. FIG. 4 is a view showing a state where the core wires 4 are separated. As shown in FIG. 3, a rotating device 125 that rotates the multi-core shielded cable 1 around the axis is connected to the fixed clamp 120 arranged forward of the core wire separation device 40. The rotating device 125 rotates the multi-core shielded cable 1 so that the drain wire 3 is positioned at the 0 o'clock position (see FIG. 4). Provided upward of the fixed clamp 120 is a detection device 140 that detects the position of the drain wire 3 in the circumferential direction with the multi-core shielded cable 1 being gripped by the fixed clamp 120. The rotation of the rotating device 125 is controlled based on the detection by the detection device 140. The core wire separation device 40 separates the drain wire 3 and the core wires 4 by leaving the drain wire 3 positioned at the 0 o'clock direction and bending downward the core wires 4 located at other positions.

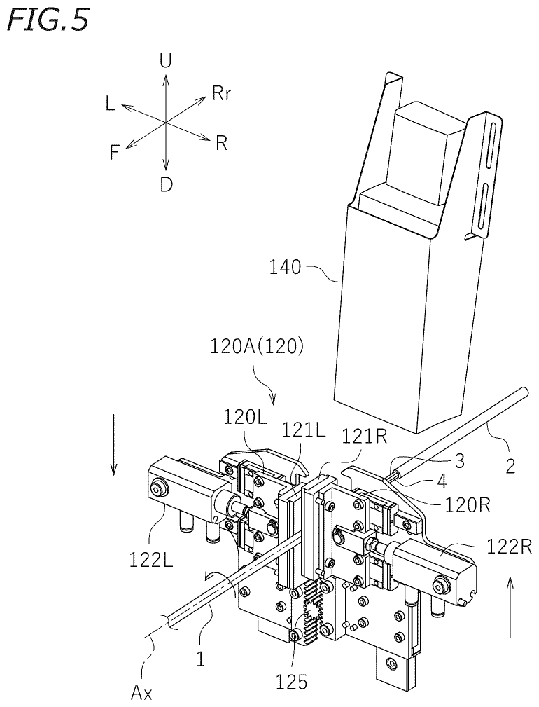

FIG. 5 is a perspective view of the fixed clamp 120 forward of the core wire separation device 40 and the detection device 140. Hereinafter, a fixed clamp 120 that is forward of the core wire separation device 40 is distinguished from other fixed clamps 120 will be denoted by using reference sign 120A. When using reference sign 120A, the fixed clamp 120A forward of the core wire separation device 40 may be referred to simply as the fixed clamp 120A. As with the other fixed clamps 120, the fixed clamp 120A grips the multi-core shielded cable 1 so that the longitudinal direction of the multi-core shielded cable 1 coincides with the orthogonal direction. As shown in FIG. 5, the fixed clamp 120A includes a left clamp 120L that contacts, from the left side, the multi-core shielded cable 1, which has been moved to a position forward of the core wire separation device 40, and a right clamp 120R that contacts, from the right side, the multi-core shielded cable 1. The left clamp 120L and the right clamp 120R include clamping plates 121L and 121R, respectively, that are configured to be movable in the conveying direction to contact or separate from the multi-core shielded cable 1. The left clamp 120L and the right clamp 120R also include driving sections 122L and 122R that move the clamping plates 121L and 121R in the conveying direction and cause the clamping plates 121L and 121R to grip or release the multi-core shielded cable 1. The driving sections 122L and 122R are herein air cylinders. Note however that there is no particular limitation on the type of the driving sections 122L and 122R.

The rotating device 125 rotates the multi-core shielded cable 1 gripped by the fixed clamp 120A around a predetermined rotation axis Ax extending in the orthogonal direction. The rotation axis Ax herein coincides with the axis of the multi-core shielded cable 1 when being gripped by the fixed clamp 120A. The rotating device 125 moves the left clamp 120L downward or upward, and the right clamp 120R upward or downward. The rotating device 125 moves the left clamp 120L and the right clamp 120R in directions such that the left clamp 120L and the right clamp 120R shift from each other. Thus, the rotating device 125 rotates the multi-core shielded cable 1 around the rotation axis Ax. FIG. 5 shows, by arrows, a case where the left clamp 120L is moved downward and the right clamp 120R is moved upward. The rotation direction of the multi-core shielded cable 1 is determined in accordance with the position of the drain wire 3 in the circumferential direction detected by the detection device 140.

The detection device 140 is a device that detects the position in the circumferential direction of the drain wire 3, and is a camera, for example. Here, the detection device 140 successively detects the position of the upstream-side drain wire 3 for the circumferential direction of the upstream-side portion 1u of the multi-core shielded cable 1, and the position of the downstream-side drain wire 3 for the circumferential direction of the downstream-side portion 1d. The detection device 140 identifies the drain wire 3 using the difference in brightness with respect to the core wires 4 from a captured image of the multi-core shielded cable 1, for example. Note however that the method of detecting the drain wire 3 using the detection device 140 is not limited to the method of capturing an image of the drain wire 3. The position of the drain wire 3 may be detected, for example, by a probe that passes an electric current through the drain wire 3. Herein, the detection device 140 is arranged at the 0 o'clock position around the rotation axis Ax as viewed in the front-rear direction (as viewed in the direction of the axis of the rotation axis Ax). As will be explained in the description of a controller 200, the controller 200 rotates the multi-core shielded cable 1 so that the drain wire 3 faces toward the detection device 140 based on the detection by the detection device 140. As a result, the drain wire 3 is moved to the 0 o'clock position. By positioning the drain wire 3 at a position in the circumferential direction such as to face toward the detection device 140, it is possible to accurately control the position of the drain wire 3. Note that the position of the detection device 140 around the rotation axis Ax is not limited to the 0 o'clock position, and may be any of various positions in the circumferential direction.

As shown in FIG. 3 and FIG. 4, the core wire separation device 40 includes a pair of left and right hooks 41, a hook opening/closing device 42, and a hook moving device 43. The pair of hooks 41 opens and closes by moving in the left-right direction so as to move away from or toward each other. The hook opening/closing device 42 is a driving section that opens and closes the pair of hooks 41. The hook moving device 43 is a driving section that moves the pair of hooks 41 in the up-down direction. When the pair of hooks 41 is closed, the pair of hooks 41 encloses the multi-core shielded cable 1, except for the 0 o'clock direction, as viewed in the front-rear direction. When the pair of hooks 41 is moved downward by the hook moving device 43 in this state, the plurality of core wires 4 are hooked by the pair of hooks 41 and bent downward. The drain wire 3 is left remaining not hooked by the pair of hooks 41. Thus, the drain wire 3 is separated from the plurality of core wires 4. As shown in FIG. 3, the core wire separation device 40 also includes a pull-out device 44 that completely pulls out the semi-stripped sheath 2 from the multi-core shielded cable 1.

The tube attaching device 50 attaches the insulator heat-shrink tube 6 to the drain wire 3, thereby performing the insulation process for the drain wire 3. The tube attaching device 50 attaches the heat-shrink tube 6 to the drain wire 3, which has been moved so as to face toward the detection device 140 (herein, the 0 o'clock position). With the position of the drain wire 3 in the circumferential direction determined, it is easy to attach the heat-shrink tube 6 to the drain wire 3. The tube attaching device 50 includes a tube reel 51 around which the uncut heat-shrink tube 6 is wound, a cutting device 52 that cuts the heat-shrink tube 6 to a predetermined length, an insertion device 53 that inserts the drain wire 3 into the heat-shrink tube 6, and a heating device 54 that heats the heat-shrink tube 6 with the drain wire 3 inserted therethrough. Since the drain wire 3 has been moved to the 0 o'clock position (in front of the insertion device 53), the insertion device 53 can place the heat-shrink tube 6 over the drain wire 3 by holding and moving the heat-shrink tube 6 forward. Note however that the method of insulating the drain wire 3 is not limited to the method of placing the heat-shrink tube 6 over the drain wire 3. The drain wire 3 may be insulated by wrapping the drain wire 3 with insulating tape, for example.

The relay device 150 grips the multi-core shielded cable 1 as the multi-core shielded cable 1, after completion of the insulation process of the drain wire 3, is moved by the conveying clamp 111 on the downstream side in the conveying direction relative to the tube attaching device 50. As the relay device 150 grips the multi-core shielded cable 1, the conveying clamp 111 releases the multi-core shielded cable 1 and returns to the upstream side in the conveying direction. Hereinafter, the position of clamps 160R and 160L (described below) of the relay device 150 when the multi-core shielded cable 1 is relayed to and from the first-step processing device 10A is referred to also as the upstream-side relay position P1. The relay device 150 hands over the multi-core shielded cable 1 to the second-step processing device 10B. Hereinafter, the position of the clamps 160R and 160L of the relay device 150 when the multi-core shielded cable 1 is relayed to and from the second-step processing device 10B is referred to also as the downstream-side relay position P2. The relay device 150 is configured to move the clamps 160R and 160L between the upstream-side relay position P1 and the downstream-side relay position P2. The details of the relay device 150 will be described later.

The alignment device 60 is arranged at the most upstream side of the second-step processing device 10B, and individually grips the drain wire 3 and the plurality of core wires 4 to align them at the same pitch. The alignment device 60 is configured to push the drain wire 3 and core wires 4 into the gripping portions 131a of the shuttle 131, which is configured to individually grip the drain wire 3 and the core wires 4. The gripping portion 131a has a plurality of grooves that can each grip an electric wire and are arranged side by side in the conveying direction. Thus, the alignment device 60 aligns the drain wire 3 and the plurality of core wires 4 so as to be arranged side by side in the conveying direction. As will be explained in more detail in the description of the relay device 150, when the drain wire 3 and the plurality of core wires 4 of the multi-core shielded cable 1 are relayed from the relay device 150 to the alignment device 60, the drain wire 3 and the plurality of core wires 4 are arranged side by side in the conveying direction. The alignment device 60 is configured to receive the drain wire 3 and the plurality of core wires 4 with a comb-shaped member having grooves arranged side by side in the conveying direction and push the drain wire 3 and the plurality of core wires 4 into the gripping members 131a.

The stripping device 70 is provided downstream relative to the alignment device 60 in the conveying direction, and strips the tip portions of the heat-shrink tube 6 covering the drain wire 3 and the covers 4b of the plurality of core wires 4. The stripping by the stripping device 70 is performed successively for the drain wire 3 and the plurality of core wires 4. In the stripping step, the stripping length and the cutting depth may differ between the drain wire 3 and the core wires 4.

The crimping device 80 is provided downstream relative to the stripping device 70 in the conveying direction, and crimps terminals 7 to the drain wire 3 and the plurality of core wires 4. The crimping of the terminals 7 by the crimping device 80 is performed successively for the drain wires 3 and the plurality of core wires 4. Herein, the crimping device 80 includes a right crimping device 80R that crimps terminals 7 to the downstream-side drain wire 3 and the core wires 4, and a left crimping device 80L that crimps terminals 7 to the upstream-side drain wire 3 and the core wires 4. The ejecting device 90 includes a tray 91 into which the multi-core shielded cable 1 is dropped after the terminals 7 are crimped.

### Configuration of Relay Device

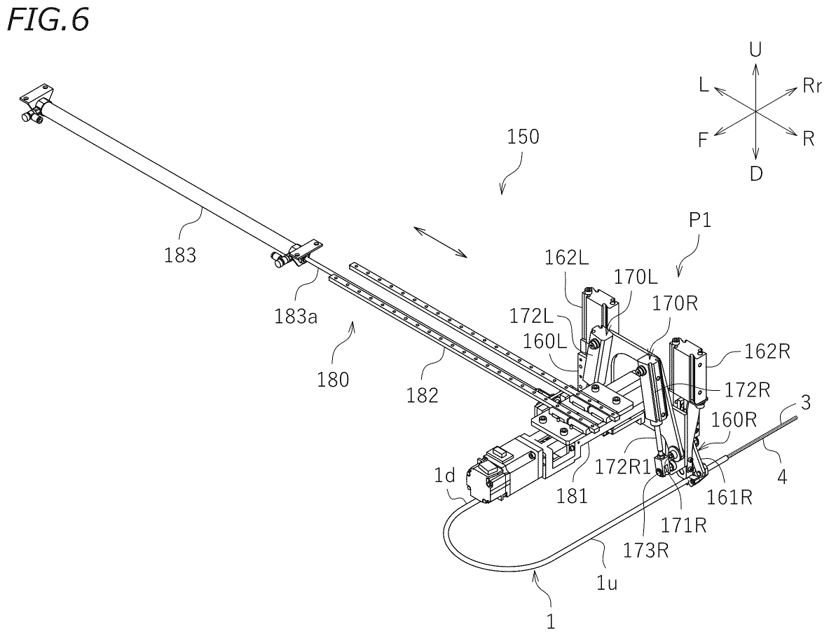

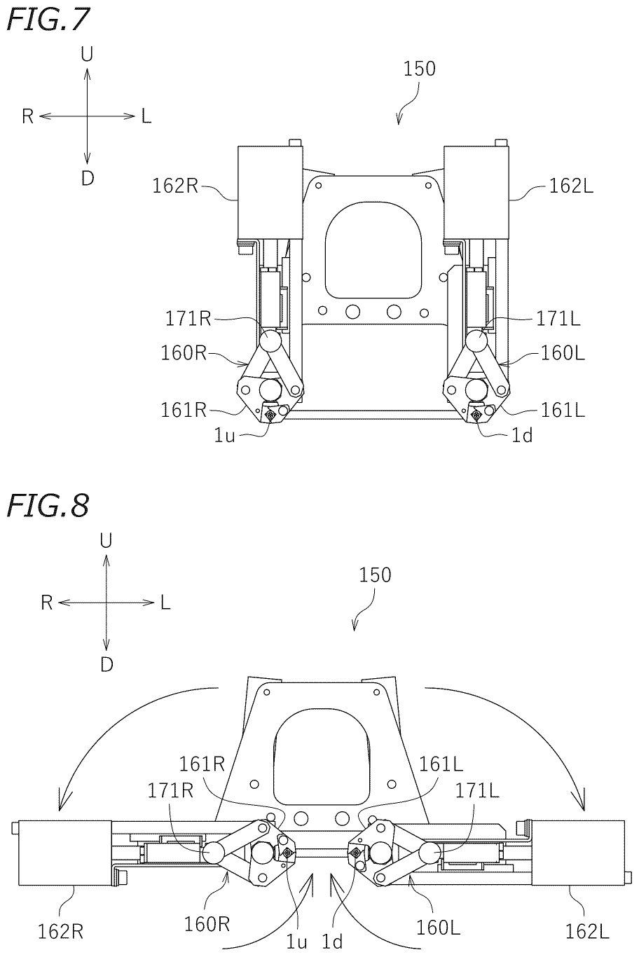

The configuration of the relay device 150 will be described below. FIG. 6 is a perspective view of the relay device 150. FIG. 7 is a rear view of the relay device 150. As shown in FIG. 6 and FIG. 7, the relay device 150 includes an upstream-side clamp 160R, an upstream-side rotating device 170R, a downstream-side clamp 160L, a downstream-side rotating device 170L, and a slide device 180.

The upstream-side clamp 160R is arranged between the first-step processing device 10A and the second-step processing device 10B, and grips the multi-core shielded cable 1 so that its longitudinal direction coincides with the orthogonal direction. Note that the upstream-side clamp 160R being “arranged between the first-step processing device 10A and the second-step processing device 10B” includes cases where the position of the upstream-side clamp 160R in the conveying direction overlaps with the position of the first-step processing device 10A or the second-step processing device 10B in the conveying direction when the multi-core cable 1 is relayed. This similarly applies also to the downstream-side clamp 160L. The upstream-side clamp 160R grips the upstream-side portion 1u of the multi-core shielded cable 1. The upstream-side rotating device 170R rotates the multi-core shielded cable 1 gripped by the upstream-side clamp 160R around an upstream-side rotation shaft 171R, which extends in the orthogonal direction. Herein, the upstream-side rotating device 170R is configured to rotate the upstream-side clamp 160R around the upstream-side rotation shaft 171R. By rotating the upstream-side clamp 160R around the upstream-side rotation shaft 171R, the upstream-side rotating device 170R rotates the upstream-side portion 1u of the multi-core shielded cable 1 around the upstream-side rotation shaft 171R.

As shown in FIG. 6, the upstream-side clamp 160R includes a pair of left and right gripping claws 161R, and a driving section 162R that moves the pair of gripping claws 161R toward or away from each other to grip or release the upstream-side portion 1u of the multi-core shielded cable 1. The driving section 162R is herein an air cylinder. Note however that there is no particular limitation on the configuration of the driving section 162R. The driving section 162R may include an electric motor, for example. FIG. 6 shows the relay device 150 at the time of receiving the multi-core shielded cable 1 from the first-step processing device 10A (also referred to as “before rotation”), at which time the gripping claws 161R are located at the lower end portion of the upstream-side clamp 160R.

As shown in FIG. 6, the upstream-side rotating device 170R includes an upstream-side rotation shaft 171R that rotatably supports the upstream-side clamp 160R, an air cylinder 172R having a telescopic rod 172R1, and a connecting portion 173R that swingably connects together the rod 172R1 and the upstream-side clamp 160R. The upstream-side rotation shaft 171R is provided so as to be off the line extending along the axis of the upstream-side portion 1u of the multi-core shielded cable 1 while the upstream-side clamp 160R is gripping the upstream-side portion 1u. Therefore, as the rod 172R1 extends and collapses, the multi-core shielded cable 1 revolves around the upstream-side rotation shaft 171R rather than rotating around the axis in place. As shown in FIG. 6, the rod 172R1 is extended in the state before the upstream-side clamp 160R is rotated.

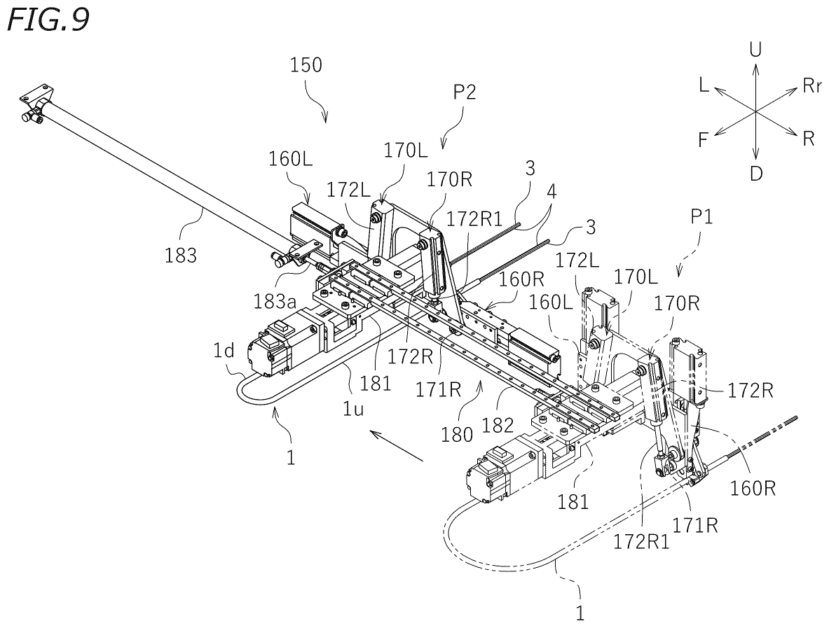

FIG. 8 is a rear view of the relay device 150 after the upstream-side clamp 160R and the downstream-side clamp 160L are rotated. When the rod 172R1 collapses (see FIG. 9), the upstream-side clamp 160R rotates counterclockwise as viewed from the rear side (clockwise as viewed from the front side) as shown in FIG. 8. The upstream-side portion 1u of the multi-core shielded cable 1 gripped by the upstream-side clamp 160R thereby moves downstream in the conveying direction. The upstream-side rotating device 170R rotates the upstream-side clamp 160R so that the line extending along the axis of the upstream-side portion 1u moves downstream in the conveying direction.

The upstream-side rotating device 170R rotates the multi-core shielded cable 1 to thereby move the drain wire 3 to a predetermined position around the upstream-side rotation shaft 171R. Here, the upstream-side rotating device 170R rotates the upstream-side clamp 160R by 90 degrees or approximately 90 degrees to move the drain wire 3 at the upstream-side portion 1u to the most upstream position in the conveying direction among the drain wire 3 and the plurality of core wires 4. In the present embodiment, the upstream-side rotating device 170R rotates the upstream-side portion 1u of the multi-core shielded cable 1 by an angle equal to the angle (here, 90 degrees) between the position of the detection device 140 around the rotation axis Ax (here, the 0 o'clock position, see FIG. 5) and the conveying direction. The upstream-side rotating device 170R thereby moves the drain wire 3 to the most upstream position in the conveying direction. Note that the relay of the multi-core cable 1 from the first-step processing device 10A to the relay device 150 is performed in such a way that the drain wire 3 is maintained at the 0 o'clock position in the upstream-side portion 1u and in the downstream-side portion 1d.

The downstream-side clamp 160L and the downstream-side rotating device 170L are configured to be in left-right symmetry with the upstream-side clamp 160R and upstream-side rotating device 170R, respectively. The downstream-side clamp 160L is provided on the downstream side in the conveying direction relative to the upstream-side clamp 160R, and grips the downstream-side portion 1d of the multi-core shielded cable 1. The downstream-side rotating device 170L rotates the downstream-side portion 1d held by the downstream-side clamp 160L around a downstream-side rotation shaft 171L, which extends in the orthogonal direction. As shown in FIG. 7, the downstream-side rotation shaft 171L is also provided so as to be off the line extending along the axis of the downstream-side portion 1d of the multi-core shielded cable 1 while the downstream-side clamp 160L is gripping the downstream-side portion 1d.

The downstream-side clamping device 160L includes a pair of left and right gripping claws 161L, and a driving section 162L that moves the pair of gripping claws 161L toward or away from each other to grip or release the downstream-side portion 1d of the multi-core shielded cable 1. The downstream-side rotating device 170L includes the downstream-side rotation shaft 171L, an air cylinder 172L (see FIG. 6) having a telescopic rod, and a connecting portion that swingably connects together the rod and the downstream-side clamp 160L. In the present embodiment, as the rod of the air cylinder 172L collapses, the downstream-side clamp 160L rotates clockwise as viewed from the rear side (counterclockwise as viewed from the front side) as shown in FIG. 7. The downstream-side portion 1d of the multi-core shielded cable 1 gripped by the downstream-side clamp 160L thereby moves upstream in the conveying direction. When the upstream-side air cylinder 172R and the downstream-side air cylinder 172L are both collapsed, the upstream-side portion 1u and the downstream-side portion 1d of the multi-core shielded cable 1 move closer to each other.

The downstream-side rotating device 170L rotates the multi-core shielded cable 1 to thereby move the drain wire 3 to a predetermined position around the downstream-side rotation shaft 171L. Here, the downstream-side rotating device 170L rotates the downstream-side clamp 160L by 90 degrees or approximately 90 degrees to move the drain wire 3 at the downstream-side portion 1d to the most downstream position in the conveying direction among the drain wire 3 and the plurality of core wires 4. Similar to the upstream-side rotating device 170R, the downstream-side rotating device 170L rotates the downstream-side portion 1d of the multi-core shielded cable 1 by an angle equal to the angle (here, 90 degrees) between the position of the detection device 140 around the rotation axis Ax (here, the 0 o'clock position) and the conveying direction.

The upstream-side clamp 160R, the upstream-side rotating device 170R, the downstream-side clamp 160L and the downstream-side rotating device 170L, and the rotating device 125 of the first-step processing device 10A together form a positioning device 100 that moves the drain wire 3 to a predetermined position in the circumferential direction based on the detection results from the detection device 140 (see FIG. 2). In the present embodiment, the positioning device 100 includes a portion provided in the first-step processing device 10A, and a portion arranged between the first-step processing device 10A and the second-step processing device 10B. Note however that as shown in other embodiments to be described below, the positioning device 100 does not need to be arranged in a distributed manner.

As shown in FIG. 2, the slide device 180 moves the clamps 160R and 160L between the upstream-side relay position P1, where the multi-core shielded cable 1 is relayed between the first-step processing device 10A and the clamps 160R and 160L, and the downstream-side relay position P2, where the multi-core shielded cable 1 is relayed between the clamps 160R and 160L and the second-step processing device 10B. As shown in FIG. 6, the slide device 180 includes a moving member 181 that supports the upstream-side rotating device 170R, the downstream-side rotating device 170L, the upstream-side clamp 160R, and the downstream-side clamp 160L. The upstream-side clamp 160R and the downstream-side clamp 160L are supported by a moving member 181 via the upstream-side rotating device 170R and the downstream-side rotating device 170L, respectively. The slide device 180 further includes a guide rail 182, which extends in the conveying direction and with which the moving member 181 is slidably engaged, and an air cylinder 183, which moves the moving member 181 along the guide rail 182. As shown in FIG. 6, the air cylinder 183 is arranged on the downstream side of the guide rail 182, and the air cylinder 183 moves the moving member 181 to the downstream side in the conveying direction by collapsing a rod 183a. The air cylinder 183 moves the moving member 181 to the upstream side in the upstream direction by extending the rod 183a. Note however that the mechanism for moving the clamps 160R and 160L between the upstream-side relay position P1 and the downstream-side relay position P2 is not limited to the one described above. For example, the slide device 180 may move the moving member 181 in the conveying direction using a ball screw and a motor that rotates the ball screw.

The relay device 150 is configured to rotate the multi-core shielded cable 1 by controlling the upstream-side rotating device 170R and the downstream-side rotating device 170L while the clamps 160R and 160L are being moved from the upstream-side relay position P1 to the downstream-side relay position P2. The relay time of the multi-core shielded cable 1 is reduced by performing the movement and the rotation of the clamps 160R and 160L in parallel. FIG. 9 is a perspective view of the relay device 150 after the upstream-side clamp 160R and the downstream-side clamp 160L have been rotated and moved laterally. At the downstream-side relay position P2 indicated by a solid line in FIG. 9, the relay device 150 hands over the multi-core shielded cable 1 to the second-step processing device 10B. At this time, the drain wire 3 at the upstream-side portion 1u of the multi-core shielded cable 1 is located at the most upstream position, and the drain wire 3 at the downstream-side portion 1d is located at the most downstream position. The two-dot-chain line in FIG. 9 shows the moving member 181 and its load while being at the upstream-side relay position P1.

Note that in the relay device 150, as the distance in the conveying direction between the upstream-side portion 1u and the downstream-side portion 1d of the multi-core shielded cable 1 (hereinafter referred to also as the pitch between the opposite ends of the multi-core shielded cable 1) is narrowed, the second-step processing device 10B is configured to accommodate the multi-core shielded cable 1 with the narrow pitch between the opposite ends. This shortens the length in the conveying direction of the second-step processing device 10B.

### Controller

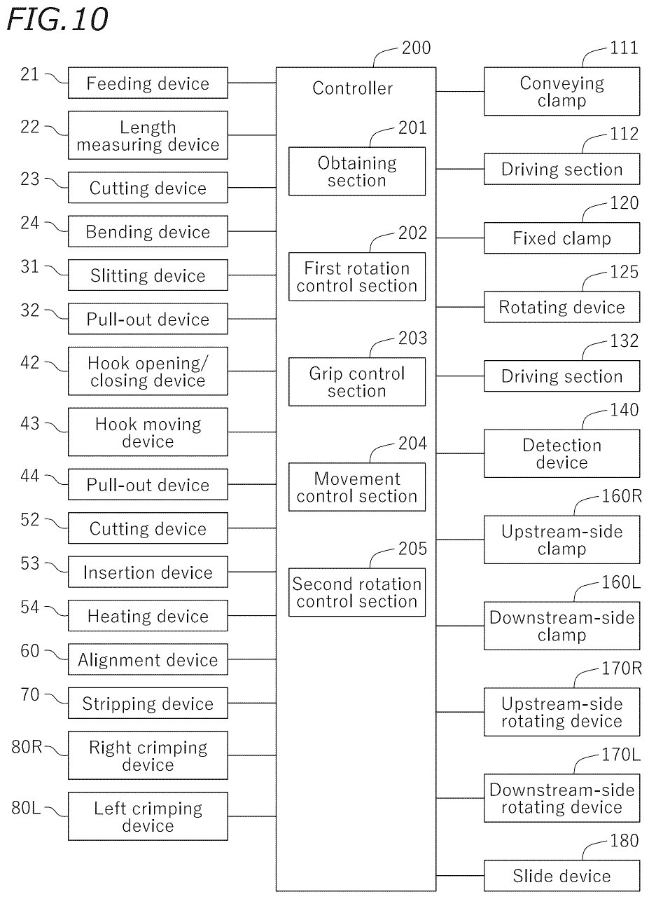

FIG. 10 is a block diagram of the processing device 10. As shown in FIG. 10, the processing device 10 includes the controller 200 that controls the first-step processing device 10A, the second-step processing device 10B, the detection device 140, the positioning device 100, and the relay device 150. More specifically, the controller 200 is connected to the feeding device 21, the length measuring device 22, the cutting device 23, and the bending device 24 of the cut-and-shape device 20, the slitting device 31 and the pull-out device 32 of the semi-stripping device 30, the hook opening/closing device 42, the hook moving device 43, and the pull-out device 44 of the core wire separation device 40, the cutting device 52, the insertion device 53, and the heating device 54 of the tube attaching device 50, the alignment device 60, the stripping device 70, the right crimping device 80R, and the left crimping device 80L. Moreover, connected to the controller 200 are the conveying clamp 111, the driving section 112, the fixed clamps 120 (the driving sections 122L and 122R), and the rotating device 125 of the conveying device 110, the driving section 132 of the shuttle conveying device 130, and the upstream-side clamp 160R (the driving section 162R), the downstream-side clamp 160L (the driving section 162L), the upstream-side rotating device 170R (the air cylinder 172R), the downstream-side rotating device 170L (the air cylinder 172L), and the slide device 180 (the air cylinder 183) of the relay device 150 or the positioning device 100. The processing device 10 may also include other devices controlled by the controller 200, but those are not shown in the figures or described here.

There is no particular limitation on the configuration of the controller 200. The controller 200 may, for example, include a central processing unit (hereinafter referred to as a CPU), a ROM storing therein a program executed by the CPU etc., a RAM, etc. These sections of the controller 200 may each be implemented by software or may be implemented by hardware. Moreover, these sections may each be a processor or a circuit. The controller 200 may be, for example, a programmable controller or a computer.

As shown in FIG. 10, the controller 200 includes an obtaining section 201 that is connected to the detection device 140 and obtains the detection results from the detection device 140. Moreover, the controller 200 includes a first rotation control section 202 as a control section for controlling the rotating device 125, and a grip control section 203, a movement control section 204, and a second rotation control section 205 as control sections for controlling the relay device 150. Although the controller 200 also includes control sections for controlling devices other than the rotating device 125 and the relay device 150, but those are not shown in the figures or described here.

The first rotating control section 202 controls the rotating device 125 (the rotating device 125 that moves the fixed clamp 120A forward of the core wire separation device 40) based on the detection by the detection device 140, and rotates the multi-core shielded cable 1 so that the drain wire 3 faces toward the detection device 140. Here, the first rotation control section 202 successively rotates the upstream-side portion 1u and the downstream-side portion 1d of the multi-core shielded cable 1 so that the drain wire 3 faces toward the detection device 140 based on the detection by the detection device 140.

The grip control section 203 controls the upstream-side clamp 160R and the downstream-side clamp 160L of the relay device 150 to grip the upstream-side portion 1u and the downstream-side portion 1d of the multi-core shielded cable 1, respectively. After the upstream-side portion 1u and the downstream-side portion 1d are rotated, the grip control section 203 controls the upstream-side clamp 160R and the downstream-side clamp 160L to release the upstream-side portion 1u and the downstream-side portion 1d.

After the multi-core shielded cable 1 has been received from the first-step processing device 10A at the upstream-side relay position P1, the movement control section 204 controls the slide device 180 to move the upstream-side clamp 160R and the downstream-side clamp 160L from the upstream-side relay position P1 to the downstream-side relay position P2. When the process of handing over the multi-core shielded cable 1 to the second-step processing device 10B is complete at the downstream-side relay position P2, the movement control section 204 controls the slide device 180 to move the upstream-side clamp 160R and the downstream-side clamp 160L from the downstream-side relay position P2 to the upstream-side relay position P1.

The second rotation control section 205 controls the upstream-side rotating device 170R to rotate the upstream-side portion 1u of the multi-core shielded cable 1, and moves the drain wire 3 at the upstream-side end portion to a predetermined position around the upstream-side rotation shaft 171R. Moreover, the second rotation control section 205 controls the downstream-side rotating device 170L to rotate the downstream-side portion 1d of the multi-core shielded cable 1, and moves the drain wire 3 at the downstream-side end portion to a predetermined position around the downstream-side rotation shaft 171L. Specifically, the upstream-side rotating device 170R rotates the upstream-side portion 1u of the multi-core shielded cable 1 so that the drain wire 3 moves to the most upstream position in the conveying direction among the drain wire 3 and the plurality of core wires 4. Moreover, the downstream-side rotating device 170L rotates the downstream-side portion 1d of the multi-core shielded cable 1 so that the drain wire 3 moves to the most downstream position in the conveying direction among the drain wire 3 and the plurality of core wires 4. In the present embodiment, the second rotation control section 205 controls the upstream-side rotating device 170R and the downstream-side rotating device 170L to move the drain wire 3 at the upstream-side end portion to a predetermined position in the circumferential direction while the upstream-side clamp 160R and the downstream-side clamp 160L are moved from the upstream-side relay position P1 to the downstream-side relay position P2 by the control of the movement control section 204.

In the present embodiment, the rotation angle of the multi-core shielded cable 1 at the relay device 150 is determined by the mechanism of the relay device 150, and does not involve electrical position control. However, the above control may be performed by electrical position control. In that case, the upstream-side rotating device 170R and the downstream-side rotating device 170L may include a servomotor or a stepping motor, for example. The “control of the upstream-side rotating device 170R and the downstream-side rotating device 170L” may include timing control without position control, as in the present embodiment, as well as control with position control.

The controller 200 controls the positioning device 100 (here, the rotating device 125, the upstream-side rotating device 170R, and the downstream-side rotating device 170L) based on the detection results from the detection device 140, and moves the upstream-side and downstream-side drain wires 3 to predetermined positions around the upstream-side rotation shaft 171R and the downstream-side rotation shaft 171L, respectively. The controller 200 drives the upstream-side rotating device 170R and the downstream-side rotating device 170L immediately before the multi-core shielded cable 1 is handed over to the second-step processing device 10B. Thus, the upstream-side and downstream-side drain wires 3 are moved to predetermined positions around the upstream-side rotation shaft 171R and the downstream-side rotation shaft 171L, respectively.

### Processing of Multi-Core Shielded Cable

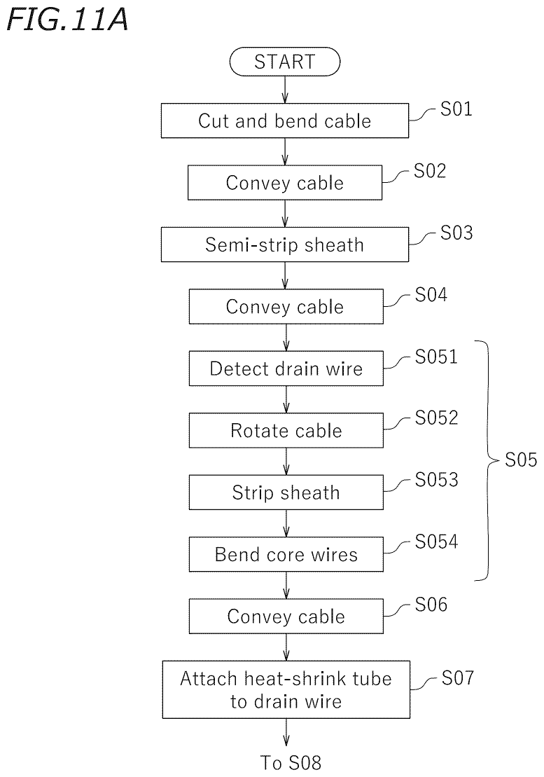

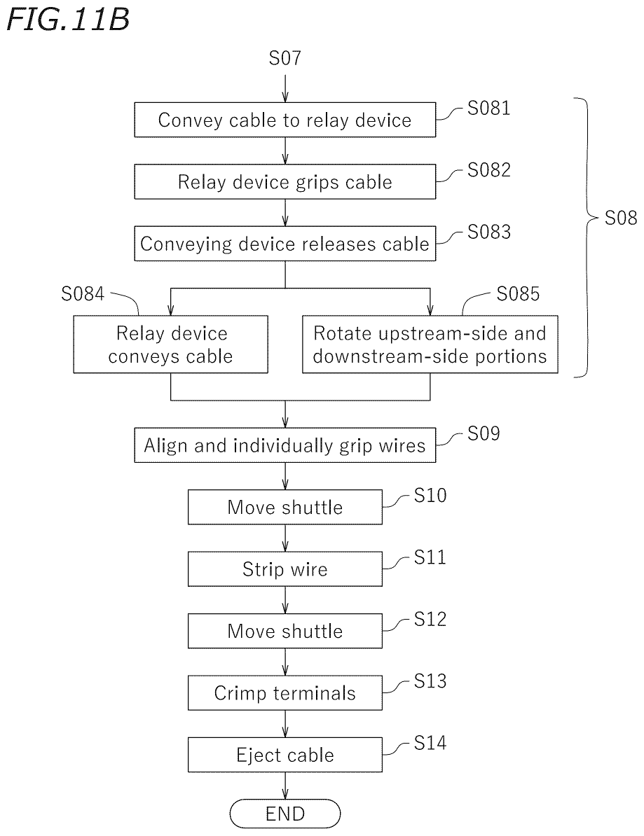

Hereinafter, the processing of the multi-core shielded cable 1 will be described with reference to flow charts. FIG. 11A and FIG. 11B are flow charts showing the process of the multi-core shielded cable 1. In FIGS. 11A, 11B and the description thereof, the details of the steps are omitted, except for the step of rotating in the core wire separation step and relaying the multi-core shielded cable 1. In FIGS. 11A and 11B, the multi-core shielded cable 1 is referred to simply as “cable”.

As shown in FIG. 11A, in step S01 of the processing process of the multi-core shielded cable 1, the multi-core shielded cable 1 is cut to a predetermined length and bent into a U-letter shape by the cut-and-shape device 20. In step S02, the multi-core shielded cable 1 is conveyed downstream in the conveying direction and moved to a position forward of the semi-stripping device 30. In step S03, the sheath 2 of the multi-core shielded cable 1 is semi-stripped. Note that although it is omitted in the description of the steps and FIGS. 11A, 11B, the semi-stripping of the sheath 2 is performed successively on the downstream-side portion 1d and the upstream-side portion 1u of the multi-core shielded cable 1, which is bent in a U-letter shape. This similarly applies also to other processing steps. In step S04, the multi-core shielded cable 1 is conveyed forward of the core wire separation device 40. In step S05, the core wires 4 of the multi-core shielded cable 1 are separated by the core wire separation device 40. While the core wires 4 of the downstream-side portion 1d are separated, the sheath 2 of the upstream-side portion 1u may be semi-stripped at the same time. This similarly applies also to other successive processes. Note however that the process for the downstream-side portion 1d and the process for the upstream-side portion 1u do not need to be performed simultaneously.

Step S05 includes step S051 of detecting the position of drain wire 3, step S052 of rotating the multi-core shielded cable 1 based on the detected position of the drain wire 3, step S053 of completely pulling out the sheath 2, and step S054 of bending the core wires 4 at the downstream-side end portion. In step S051, the position of the drain wire 3 in the circumferential direction is identified by the detection device 140. In step S052, the multi-core shielded cable 1 is rotated so that the drain wire 3 is at the 0 o'clock position by moving the left clamp 120L and the right clamp 120R of the fixed clamp 120A so that they are shifted from each other in the up-down direction. The detection device 140 confirms that the drain wire 3 has reached the 0 o'clock position. In step S053, the sheath 2 on the tip side of the cut is pulled out of the multi-core shielded cable 1. In step S054, the hooks 41 are hooked onto the core wires 4 and the core wires 4 are bent downward.

In step S06, the multi-core shielded cable 1 is conveyed and moved to a position forward of the tube attaching device 50. In step S07, the heat-shrink tube 6 is attached to the drain wire 3. This completes the process by the first-step processing device 10A.

In step S08, the multi-core shielded cable 1 is conveyed from the first-step processing device 10A to the second-step processing device 10B via the relay device 150. Step S08 includes step S081 of conveying the multi-core shielded cable 1 by the conveying device 110 to a position opposing the relay device 150, step S082 in which the relay device 150 grips the multi-core shielded cable 1, step S083 in which the conveying device 110 releases the multi-core shielded cable 1, step S084 of conveying the multi-core shielded cable 1 with the relay device 150, and step S085 of rotating the upstream-side portion 1u and the downstream-side portion 1d of the multi-core shielded cable 1. Before step S082, the upstream-side clamp 160R and the downstream-side clamp 160L of the relay device 150 have been moved to the upstream-side relay position P1. Here, steps S084 and S085 are performed simultaneously.

The detailed description of steps S081 to S083 is omitted. In step S084, the multi-core shielded cable 1 is conveyed to the downstream-side relay position P2. In step S085, which is performed simultaneously with step S084, the upstream-side clamp 160R and the downstream-side clamp 160L are rotated 90 degrees inward in the conveying direction of the relay device 150. Thus, the drain wire 3 and the plurality of core wires 4 at the upstream-side end portion are arranged side by side so that the drain wire 3 is located at the most upstream (outermost) position. Moreover, the drain wire 3 and the plurality of core wires 4 at the downstream-side end portion are arranged side by side so that the drain wire 3 is located at the most downstream (outermost) position. Furthermore, the distance in the conveying direction between the upstream-side portion 1u and the downstream-side portion 1d (the pitch between the opposite ends) of the multi-core shielded cable 1 is shortened.

In step S09, the drain wire 3 and the core wires 4 at the upstream-side end portion and the downstream-side end portion are pushed into the gripping portion 131a of the shuttle 131 by the alignment device 60. Thus, the drain wires 3 and the plurality of core wires 4 on the upstream and downstream side are individually gripped while being aligned so that they are arranged side by side in a predetermined order in the conveying direction.

In step S10, the shuttle 131 is moved downstream in the conveying direction, and the multi-core shielded cable 1 is moved to a position forward of the stripping device 70. In step S11, the heat-shrink tube 6 covering the drain wire 3 and the cover 4b of the core wires 4 are stripped by the stripping device 70. The stripping in step S11 is performed sequentially for the drain wire 3 and the core wires 4. At this time, the drain wire 3 is located at the most downstream or upstream side in the conveying direction. Therefore, the stripping device 70 performs the stripping process set for the drain wire 3 for the electric wire (the number of electric wires is known in advance, and it is the first or last electric wire) located at the most downstream or upstream side in the conveying direction. The stripping device 70 performs the stripping process set for the core wires 4 for the other electric wires.

In step S12, the shuttle 131 is moved so that the multi-core shielded cable 1 is located forward of the crimping device 80. In step S13, the terminal 7 is crimped to the drain wire 3 and the plurality of core wires 4 by the crimping device 80. The crimping in step S13 is also performed sequentially for the drain wire 3 and the core wires 4. Therefore, also in the crimping step, the position (order) of the drain wire 3 is determined, and it is therefore possible to easily and reliably perform the step.

In step S14, the multi-core shielded cable 1 is ejected. This completes the processing of the multi-core shielded cable 1. Note that the processing flow for the multi-core shielded cable 1 described above is merely one preferred example, and the processing procedure for the multi-core shielded cable 1 is not limited to this.

### Functions/Effects of Embodiment

The functions and effects that can be achieved by the processing device 10 for the multi-core shielded cable 1 according to the present embodiment will now be described.

The processing device 10 for the multi-core shielded cable 1 according to the present embodiment includes the detection device 140 that detects the position of the drain wire 3 in the circumferential direction. The positioning device 100 includes the upstream-side clamp 160R that grips the multi-core shielded cable 1 so that its longitudinal direction coincides with the orthogonal direction, and the upstream-side rotating device 170R that rotates the multi-core shielded cable 1 gripped by the upstream-side clamp 160R around the upstream-side rotation shaft 171R that extends in the orthogonal direction. The controller 200 controls the positioning device 100 based on the detection results from the detection device 140, and moves the upstream-side drain wire 3 to a predetermined position around the upstream-side rotation shaft 171R. Here, the controller 200 drives the rotating device 125 and the upstream-side rotating device 170R to thereby move the upstream-side drain wire 3 to a predetermined position around the upstream-side rotation shaft 171R.

Of the processing for the multi-core shielded cable 1, the processing of the tip portion of the drain wire 3 and the core wires 4 is performed individually for each electric wire. Therefore, it is preferred that the drain wire 3 and the core wires 4 are recognized individually before the processing by the second-step processing device 10B. Since the processing for the drain wire 3 and the processing for the core wires 4 are different in many cases, it is preferred that at least the drain wire 3 and the core wires 4 are recognized separately. In the processing by the second-step processing device 10B, such as stripping or crimping, the process conditions may be made different for the drain wire 3 and for the core wires 4, and distinguishing between the drain wire 3 and the core wires 4 makes it easier to set the process conditions. With the processing device 10 according to the present embodiment, the multi-core shielded cable 1 is rotated so that the drain wire 3 is moved to a predetermined position in the circumferential direction before being conveyed to the second-step processing device 10B that performs the processing of the tip portion. Based on the position of the drain wire 3 after being moved, it is possible to distinguish the drain wire 3 from the core wires 4.

Note that while the upstream-side clamp 160R and upstream-side rotating device 170R are used as examples in above description of the functions and effects, the functions and effects achieved by the downstream-side clamp 160L and the downstream-side rotating device 170L are the same.

In the present embodiment, the upstream-side rotating device 170R rotates the multi-core shielded cable 1 so that the drain wire 3 moves to the most upstream position in the conveying direction among the drain wire 3 and the core wires 4. The downstream-side rotating device 170L rotates the multi-core shielded cable 1 so that the drain wire 3 moves to the most downstream position in the conveying direction among the drain wire 3 and the core wires 4. With such a processing device 10, the drain wire 3 is located at the end of the second-step processing device 10B in the conveying direction. Thus, the processing for the drain wire 3 is the first or last among the drain wire 3 and the core wires 4. Therefore, where the processing for the drain wire 3 and the processing for the core wires 4 are different, the number of setup changes can be minimized.

In the present embodiment, the detection device 140 is configured to detect the position of the drain wire 3 in the circumferential direction while the multi-core shielded cable 1 is gripped by the fixed clamp 120A of the first-step processing device 10A. The controller 200 controls the rotating device 125 based on the detection by the detection device 140 to rotate the multi-core shielded cable 1 so that the drain wire 3 faces toward the detection device 140, and then control the upstream-side rotating device 170R and the downstream-side rotating device 170L to move the upstream-side and downstream-side drain wires 3 to predetermined positions.

With such a processing device 10, the position in the circumferential direction of the drain wire 3, which is gripped by the fixed clamp 120A of the first-step processing device 10A, is detected by the detection device 140, and the position of the drain wire 3 in the circumferential direction is set to a position that faces toward the detection device 140. This determines the position of the drain wire 3 in the circumferential direction, and therefore makes easier the processing of the drain wire 3 and the core wires 4 in the first-step processing device 10A (here, the core wire separation step and the heat-shrink tube attaching step). In the first-step processing device 10A, the position of the drain wire 3 in the circumferential direction is set to a position that faces toward the detection device 140, thus enabling accurate positioning of the drain wire 3. Since the drain wire 3 can be accurately positioned in the first-step processing device 10A, positioning of the drain wire 3 in the relay device 150 can also be done accurately.

With the processing device 10 according to the present embodiment, the position of the drain wire 3 in the circumferential direction is determined by the action of the rotating device 125, and it is therefore possible to easily attach the heat-shrink tube 6. As a result, it is possible to improve the processing efficiency of the processing device 10.

With the processing device 10 according to the present embodiment, the position of the drain wire 3 can be determined at the opposite end portions of the multi-core shielded cable 1, which is bent in a U-letter shape, to successively process the opposite end portions. Therefore, the drain wire 3 and the core wires 4 can be distinguished from each other at both ends of the multi-core shielded cable 1. By bending the multi-core shielded cable 1 in a U-letter shape, the opposite end portions can be processed simultaneously, and the processing efficiency of the processing device 10 can be improved.

In the present embodiment, the upstream-side rotation shaft 171R is provided so as to be off the line extending along the axis of the upstream-side portion 1u of the multi-core shielded cable 1 while the upstream-side clamp 160R is gripping the upstream-side portion 1u. The upstream-side rotating device 170R is configured to rotate the upstream-side clamp 160R around the upstream-side rotation shaft 171R, and rotates the upstream-side clamp 160R so that the line extending along the axis of the upstream-side portion 1u moves downstream in the conveying direction. The downstream-side rotation shaft 171L is provided so as to be off the line extending along the axis of the downstream-side portion 1d of the multi-core shielded cable 1 while the downstream gripping clamp 160L is gripping the downstream-side portion 1d. The downstream-side rotating device 170L is configured to rotate the downstream-side clamp 160L around the downstream-side rotation shaft 171L, and rotates the downstream-side clamp 160L so that the line extending along the axis of the downstream-side portion 1d moves upstream in the conveying direction.

With such a processing device 10, the opposite ends of the multi-core shielded cable 1 move closer to each other in the conveying direction, and the distance between the opposite ends becomes narrower. Therefore, it is possible to shorten the length of the second-step processing device 10B in the conveying direction, thereby improving the space efficiency. Note that the same effect can be achieved by only rotating the downstream-side portion 1d to the upstream side or by only rotating the upstream-side portion 1u to the downstream side.

In the present embodiment, the upstream-side clamp 160R and the downstream-side clamp 160L are provided in the relay device 150. The relay device 150 is configured to, by means of the upstream-side clamp 160R and the downstream-side clamp 160L, receive the multi-core shielded cable 1 from the first-step processing device 10A, and hand over the multi-core shielded cable 1 to the second-step processing device 10B.

With such a processing device 10, the positioning device 100 and the relay device 150 are partially shared. This allows the processing device 10 to be made more compact, thereby improving the space efficiency. It is also possible to reduce the number of parts in the processing device 10, thereby reducing costs.

In the present embodiment, the controller 200 controls the slide device 180 to move the clamps 160R and 160L from the upstream-side relay position P1 to the downstream-side relay position P2, and controls the upstream-side rotating device 170R and the downstream-side rotating device 170L to move the upstream-side and downstream-side drain wires 3 while the clamps 160R and 160L are moved from the upstream-side relay position P1 to the downstream-side relay position P2.

With such a processing device 10, it is possible to position the drain wire 3 in the circumferential direction while moving the multi-core shielded cable 1 in the conveying direction. Thus, it is possible to shorten the cycle time for processing the multi-core shielded cable 1.

### Variation

A variation of the embodiment described above will now be described. In the following description of a variation and other embodiments, the same reference signs as those used in the embodiment described above will be used for components that perform the same functions as those in the embodiment described above. Any redundant descriptions will be omitted or simplified.

In this variation, the controller 200 is configured to be capable of controlling the bending device 24 so that the position of the upstream tip of the multi-core shielded cable 1 (the tip of the upstream-side portion 1u) and the position of the downstream tip of the multi-core shielded cable 1 (the tip of downstream-side portion 1d) are shifted from each other by a predetermined distance in the orthogonal direction. In order to achieve this, the pair of conveying clamps 111 forward of the cut-and-shape device 20 are each configured to be able to move their positions in the front-rear direction. By shifting, in the orthogonal direction, the position of the upstream tip and the position of the downstream tip of the multi-core shielded cable 1, which is bent in a U-letter shape, the sheath strip length of the upstream-side end portion and the sheath strip length of the downstream-side end portion can be made different from each other. This allows the length of the electric wire that is exposed at the upstream-side end portion and the length of the electric wire that is exposed at the downstream-side end portion to be different from each other. The semi-stripping device 30 cuts the sheath 2 at the upstream-side end portion and the sheath 2 at the downstream-side end portion at the same position in the orthogonal direction. For the devices from the semi-stripping device 30 to the tube attaching device 50, they can be more simply configured if the cut position of the sheath 2 is the same for both ends of the multi-core shielded cable 1.

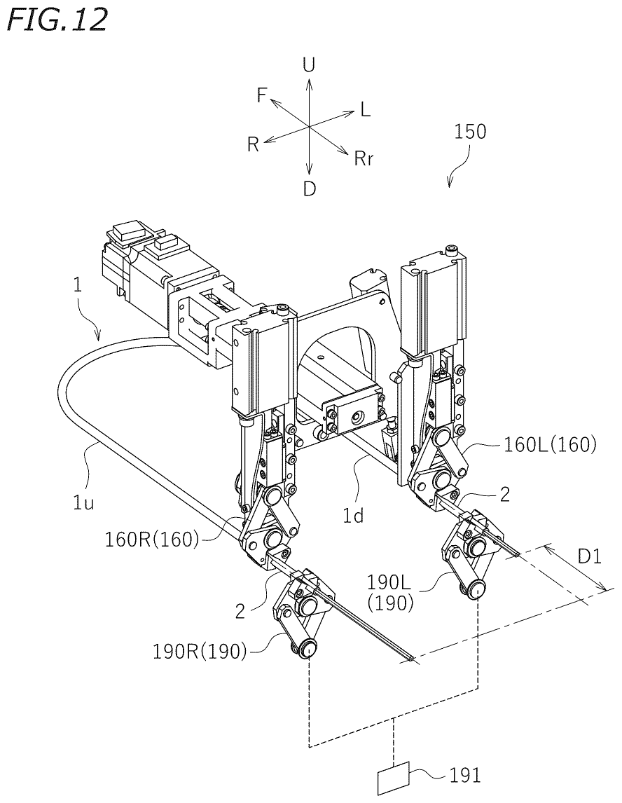

FIG. 12 is a perspective view showing the relay device 150 gripping the multi-core shielded cable 1 where the tip positions of the opposite end portions are different from each other. As shown in FIG. 12, when the multi-core shielded cable 1, in which the tip positions of the opposite end portions are different from each other, is gripped by the relay device 150, the position in the orthogonal direction of the upstream tip and the position in the orthogonal direction of the downstream tip of the multi-core shielded cable 1 are shifted from each other by a predetermined distance D1. Note that in this state, the tip position of the sheath 2 of the upstream-side portion 1u and the tip position of the sheath 2 of the downstream-side portion 1d are aligned for the orthogonal direction.

As shown in FIG. 12, in this variation, the relay device 150 includes an upstream-side adjustment clamp 190R and a downstream-side adjustment clamp 190L. The upstream-side adjustment clamp 190R is provided side by side with the upstream-side clamp 160R in the orthogonal direction, and grips the upstream-side portion 1u of the multi-core shielded cable 1. Here, the upstream-side adjustment clamp 190R is arranged rearward relative to the upstream-side clamp 160R. The downstream-side adjustment clamp 190L is provided side by side with the downstream-side clamp 160L in the orthogonal direction, and grips the downstream-side portion 1d of the multi-core shielded cable 1. The downstream-side adjustment clamp 190L is arranged rearward relative to the downstream-side clamp 160L. The pair of adjustment clamps 190, including the upstream-side adjustment clamp 190R and the downstream-side adjustment clamp 190L, is configured to be movable in the orthogonal direction, and is moved in the orthogonal direction by a moving device 191. Here, the pair of adjustment clamps 190 moves integrally and synchronously.

The processing device 10 according to this variation is configured to align the position in the orthogonal direction of the upstream tip of the multi-core shielded cable 1 and the position in the orthogonal direction of the downstream tip of the multi-core shielded cable 1, by means of the relay device 150 and the pair of adjustment clamps 190. For the devices from the alignment device 60 to the crimping device 80, they can be more simply configured if the tip positions of the electric wires are aligned at both ends of the multi-core shielded cable 1.

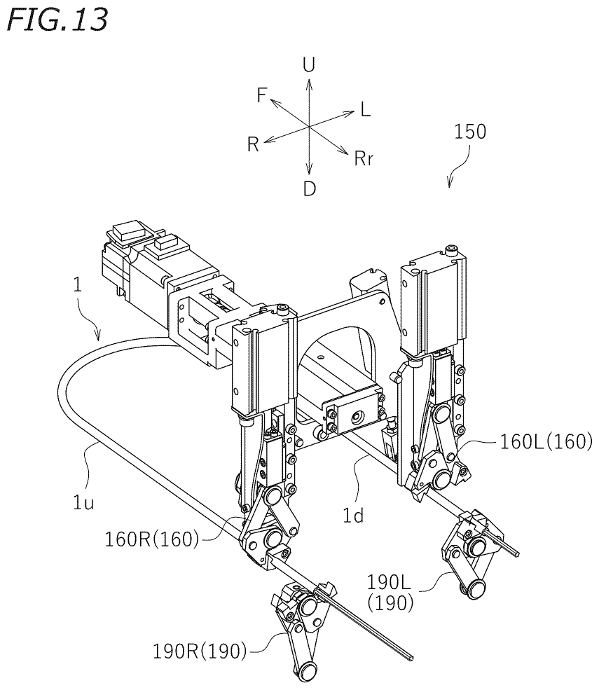

FIG. 13 is a perspective view showing the relay device 150 immediately after starting the work of aligning the tip positions of the opposite end portions of the multi-core shielded cable 1. As shown in FIG. 13, in the process of aligning the tip positions of the opposite end portions of the multi-core shielded cable 1, the adjustment clamp 190 (the adjustment clamp 190R on the upstream side in the example of FIG. 13) that is gripping the straight portion with the longer strip length, i.e., the one that is more protruding in the orthogonal direction (the upstream-side portion 1u in the example of FIG. 13), releases the multi-core shielded cable 1. Moreover, the clamp 160 (the downstream-side clamp 160L in the example of FIG. 13) that is gripping the straight portion with the shorter strip length, i.e., the one that is more receding in the orthogonal direction (the downstream-side portion 1d in the example of FIG. 13), releases the multi-core shielded cable 1. Thus, the straight portion that is released by the clamp 160 while being gripped by the adjustment clamp 190, i.e., the one that is more receding in the orthogonal direction (the downstream-side portion 1d in the example of FIG. 13), can be moved by the movement of the adjustment clamp 190 (here, the downstream-side adjustment clamp 190L).

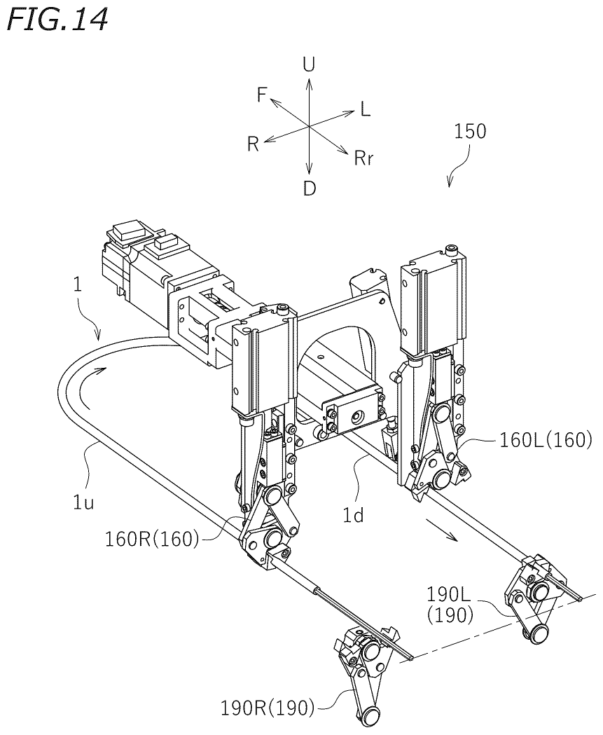

From the state shown in FIG. 13, the processing device 10 moves the pair of adjustment clamps 190 rearward. FIG. 14 is a perspective view of the relay device 150 after finishing aligning the tip positions of the opposite end portions of the multi-core shielded cable 1. In the example shown in FIG. 14, as the pair of adjustment clamps 190 are moved, the downstream-side portion 1d is pulled by the downstream-side adjustment clamp 190L and moved rearward. The upstream-side adjustment clamp 190R moves rearward without gripping the multi-core shielded cable 1. Since the portion of the multi-core shielded cable 1 that is gripped by the upstream-side clamp 160R of the relay device 150 is unmoved, the multi-core shielded cable 1 deforms so that the tip portion with the longer strip length is aligned with the other end (see the arrow in FIG. 14). Thus, the position of the upstream tip and the position of the downstream tip of the multi-core shielded cable 1 are aligned for the orthogonal direction. Although not shown in the figures, thereafter, the downstream-side clamp 160L of the relay device 150 grips again the downstream-side portion 1d of the multi-core shielded cable 1. The downstream-side adjustment clamp 190L releases the downstream-side portion 1d of the multi-core shielded cable 1.

Note that the pair of adjustment clamps 190 may be arranged rearward of the pair of clamps 160 or may be arranged forward of the pair of clamps 160. The moving device 191 may be configured to move the pair of clamps 160 in the orthogonal direction, or may be configured to move both the pair of clamps 160 and the pair of adjustment clamps 190 in the orthogonal direction. That is, the moving device 191 may be configured to move at least one of the pair of adjustment clamps 190 and the pair of clamps 160 in the orthogonal direction to thereby move the pair of adjustment clamps 190 relative to the pair of clamps 160 in the orthogonal direction.

The controller 200 may be configured to control one of the upstream-side clamp 160R and the downstream-side clamp 160L to grip the multi-core shielded cable 1, control the other to release the multi-core shielded cable 1, control the adjustment clamp 190 corresponding to the clamp 160 that has released the multi-core shielded cable 1 to grip the multi-core shielded cable 1, and control the adjustment clamp 190 corresponding to the clamp 160 that is gripping the multi-core shielded cable 1 to release the multi-core shielded cable 1. The controller 200 may be configured to control the moving device 191 to move the pair of adjustment clamps 190 relative to the pair of clamps 160 by the distance D1 in the orthogonal direction so as to align the position of the upstream tip of the multi-core shielded cable 1 in the orthogonal direction with the position of the downstream tip of the multi-core shielded cable 1 in the orthogonal direction. For example, the pair of adjustment clamps 190 may push in the straight portion of the multi-core shielded cable 1 whose tip is more protruding in the orthogonal direction, rather than pulling the straight portion of the multi-core shielded cable 1 whose tip is more receding in the orthogonal direction.

With the processing device 10 according to this variation, even if the position of the upstream tip and the position of the downstream tip are shifted from each other when the multi-core shielded cable 1 is bent, it is possible to align the position of the upstream tip with the position of the downstream tip. Therefore, it is easier to perform processing such as crimping of the terminal 7 by the second-step processing device 10B.

Note that the pair of adjustment clamps 190R and 190L may be configured to be independently movable. The function of the adjustment clamps 190 may be achieved by the conveying clamps 111.

### Other Embodiments

A preferred embodiment of the present invention has been described above. Note however that the embodiment described above is merely illustrative, and various other embodiments are possible. For example, in the embodiment described above, the upstream-side rotating device 170R and the upstream-side clamp 160R are configured to move the drain wire 3 to the most upstream position among the electric wires, and the downstream-side rotating device 170L and the downstream-side clamp 160L are configured to move the drain wire 3 to the most downstream position among the electric wires. However, the position to which the upstream-side rotating device 170R moves the drain wire 3 and the position to which the downstream-side rotating device 170L moves the drain wire 3 are not particularly limited, as long as they are predetermined positions.

In the embodiment described above, the positioning device 100 positions the drain wires 3 at opposite end portions of the multi-core shielded cable 1, which is shaped in a U-letter shape. However, the positioning device 100 may be configured to align the drain wire 3 at one end portion of the multi-core shielded cable 1. In that case, the multi-core shielded cable 1 does not need to be bent in a U-letter shape, and may be conveyed in a straight shape, for example. In that case, the number of clamps 160 of the positioning device 100 may be one.

In the embodiment described above, the rotating device 170 (representing one or both of the upstream-side rotating device 170R and the downstream-side rotating device 170L) rotates the multi-core shielded cable 1 by rotating the clamp 160. However, the clamp 160 and the rotating device 170 may be configured similar to the fixed clamp 120A and the rotating device 125 as shown in FIG. 5, for example, to rotate the multi-core shielded cable 1 without rotating the clamp 160. Alternatively, the clamp 160 may rotate around the axis of the multi-core shielded cable 1 while the multi-core shielded cable 1 is gripped. In that case, the multi-core shielded cable 1 rotates without wobbling around the axis. There is no particular limitation on the method by which the relay device 150 rotates the multi-core shielded cable 1.

In the embodiment described above, the rotation of the multi-core shielded cable 1 based on the detection of the detection device 140 is performed in the first-step processing device 10A. However, the rotation of the multi-core shielded cable 1 based on the detection of the detection device 140 may be performed between the first-step processing device 10A and the second-step processing device 10B.

For example, with an alternative preferred processing device 10 for the multi-core shielded cable 1, the detection device 140 may be configured to detect the position of the drain wire 3 in the circumferential direction while the multi-core shielded cable 1 is gripped by the clamp 160 of the relay device 150. The controller 200 may control the rotating device 170 of the relay device 150 based on the detection by the detection device 140 and move the drain wire 3 to a predetermined position after rotating the multi-core shielded cable 1 so that the drain wire 3 faces toward the detection device 140. Note that the clamp that grips and rotates the multi-core shielded cable 1 does not need to be the clamp of the relay device 150, and may be another clamp arranged between the first-step processing device 10A and the second-step processing device 10B.

With such a processing device 10 for the multi-core shielded cable 1, preliminary positioning of the drain wire 3 is performed so that the position of the drain wire 3 in the circumferential direction is set to a position that faces toward the detection device 140. This preliminary positioning of the drain wire 3 may be performed accurately because the position of the drain wire 3 in the circumferential direction is a position that faces toward the detection device 140. Since the preliminary positioning of the drain wire 3 has been performed accurately, the positioning of the drain wire 3 thereafter can also be performed more accurately.

Note that the processing device 10 may detect whether the drain wire 3 has been moved to the predetermined position in the circumferential direction by the detection device 140, without performing the preliminary positioning of the drain wire 3 described above, to control the rotating device 170 based on the detection by the detection device 140.

The clamp 160 does not need to be configured to be moved in the conveying direction. The relay device 150 may position the drain wire 3 at the location where the multi-core shielded cable 1 has been received from the conveying clamp 111 of the first-step processing device 10A, and hand over the multi-core shielded cable 1 to the second-step processing device 10B.

The multi-core cable to be processed by the processing device 10 may not be the multi-core shielded cable 1 including the drain wire 3 and one or more core wires 4. The processing device 10 is configured to distinguish a specific electric wire from other electric wires before processing the tip portion of the electric wire, and there is no limitation on the type of the multi-core cable to be handled.

The configuration of the first-step processing device 10A and the second-step processing device 10B is merely an illustrative preferred configuration, and is not limited to the above. Unless otherwise specified, the embodiment described above do not limit the present invention.

### DESCRIPTION OF REFERENCE SIGNS

1 Multi-core shielded cable
1u Upstream-side portion
1d Downstream-side portion
1m Bent portion
2 Sheath
3 Drain wire
4 Core wire
6 Heat-shrink tube
7 Terminal
10 Processing device
10A First-step processing device
10B Second-step processing device
24 Bending device
60 Tube attaching device
100 Positioning device
120A Fixed clamp (second gripping device)
125 Rotating device (second rotating device)
140 Detection device
150 Relay device
160R Upstream-side clamp (first gripping device)
160L Downstream-side clamp (downstream-side first gripping device)
170R Upstream-side rotating device (first rotating device)
170L Downstream-side rotating device (downstream-side first rotating device)
171R Upstream-side rotation shaft (first rotation shaft)
171L Downstream-side rotation shaft (another first rotation shaft)
180 Slide device (second moving device)
190R Upstream-side adjustment clamp (upstream-side third gripping device)
190L Downstream-side adjustment clamp (downstream-side third gripping device)
191 Moving device (first moving device)
200 Controller
Ax Rotation shaft (second rotation shaft)
P1 Upstream-side relay position
P2 Downstream-side relay position

1: A processing device for a multi-core shielded cable, comprising:
a first-step processing device that at least performs sheath stripping for a multi-core shielded cable including a drain wire, one or more core wire, and a sheath covering the drain wire and the core wire;
a detection device that detects a position of the drain wire for a circumferential direction of the multi-core shielded cable;
a second-step processing device arranged side by side with the first-step processing device in a predetermined conveying direction, wherein the second-step processing device performs processing of a tip portion for at least one of the drain wire and the core wire;
a positioning device including a first gripping device that grips the multi-core shielded cable so that a longitudinal direction thereof coincides with an orthogonal direction, which is orthogonal to the conveying direction, and a first rotating device that rotates the multi-core shielded cable gripped by the first gripping device around a first rotation shaft extending in the orthogonal direction;
a relay device that receives the multi-core shielded cable from the first-step processing device and hands over the multi-core shielded cable to the second-step processing device; and
a controller that controls the positioning device based on detection results from the detection device to drive at least the first rotating device and to thereby move the drain wire to a predetermined position around the first rotation shaft.

2: The processing device for a multi-core shielded cable according to claim 1, wherein the first rotating device rotates the multi-core shielded cable so that the drain wire moves to a most upstream position or a most downstream position in the conveying direction among the drain wire and the core wire.

3: The processing device for a multi-core shielded cable according to claim 1, wherein:
the positioning device includes:
a second gripping device provided in the first-step processing device that grips the multi-core shielded cable so that the longitudinal direction thereof coincides with the orthogonal direction; and
a second rotating device that rotates the multi-core shielded cable gripped by the second gripping device around a second rotation shaft extending in the orthogonal direction;
the detection device is configured to detect a position of the drain wire for the circumferential direction of the multi-core shielded cable while the multi-core shielded cable is gripped by the second gripping device; and
the controller controls the second rotating device based on detection by the detection device to rotate the multi-core shielded cable so that the drain wire faces toward the detection device, and then controls the first rotating device to move the drain wire to the predetermined position.

4: The processing device for a multi-core shielded cable according to claim 3, wherein the first-step processing device includes a tube attaching device that attaches a heat-shrink tube to the drain wire, which has been moved so as to face toward the detection device.

5: The processing device for a multi-core shielded cable according to claim 1, wherein:
the first-step processing device includes a bending device that bends the multi-core shielded cable into a U-letter shape so that opposite end portions thereof are arranged side by side in the conveying direction, to form, in the multi-core shielded cable, an upstream-side portion extending in the orthogonal direction, a downstream-side portion extending in the orthogonal direction and located downstream of the upstream-side portion in the conveying direction, and a bent portion located between the upstream-side portion and the downstream-side portion;
the detection device detects a position of the drain wire on an upstream side for the circumferential direction of the upstream-side portion, and a position of the drain wire on a downstream side for the circumferential direction of the downstream-side portion;
the first gripping device is configured to grip the upstream-side portion of the multi-core shielded cable;
the first rotating device is configured to rotate the upstream-side portion of the multi-core shielded cable;
the positioning device includes:
a downstream-side first gripping device provided on a downstream side in the conveying direction relative to the first gripping device to grip the downstream-side portion of the multi-core shielded cable; and
a downstream-side first rotating device that rotates the downstream-side portion gripped by the downstream-side first gripping device around another first rotation shaft extending in the orthogonal direction; and
the controller controls the downstream-side first rotating device to move the drain wire on the downstream side to a predetermined position around the other first rotation shaft.

6: The processing device for a multi-core shielded cable according to claim 5, wherein:
the first rotation shaft is provided so as to be off a line extending along an axis of the upstream-side portion while the first gripping device is gripping the upstream-side portion of the multi-core shielded cable; and
the first rotating device is configured to rotate the first gripping device around the first rotation shaft, and rotates the first gripping device so that the line extending along the axis of the upstream-side portion moves downstream in the conveying direction.

7: The processing device for a multi-core shielded cable according to claim 5, wherein:
the other first rotation shaft is provided so as to be off a line extending along an axis of the downstream-side portion while the downstream-side first gripping device is gripping the downstream-side portion of the multi-core shielded cable; and
the downstream-side first rotating device is configured to rotate the downstream-side first gripping device around the other first rotation shaft, and rotates the downstream-side first gripping device so that the line extending along the axis of the downstream-side portion moves upstream in the conveying direction.

8: The processing device for a multi-core shielded cable according to claim 5, further comprising:
an upstream-side third gripping device that is provided side by side with the first gripping device in the orthogonal direction, and grips the upstream-side portion of the multi-core shielded cable;
a downstream-side third gripping device that is provided side by side with the downstream-side first gripping device in the orthogonal direction, and grips the downstream-side portion of the multi-core shielded cable; and
a first moving device that moves at least one of a pair of third gripping devices including the upstream-side third gripping device and the downstream-side third gripping device and a pair of first gripping devices including the first gripping device and the downstream-side first gripping device in the orthogonal direction to thereby move the pair of third gripping devices relative to the pair of first gripping devices in the orthogonal direction, wherein:
the controller is configured to be capable of controlling the bending device so that a position of an upstream tip of the multi-core shielded cable and a position of a downstream tip of the multi-core shielded cable are shifted from each other by a predetermined distance in the orthogonal direction, and where the position of the upstream tip of the multi-core shielded cable and the position of the downstream tip of the multi-core shielded cable are shifted from each other by the predetermined distance, the controller is configured to:
control one of the first gripping device and the downstream-side first gripping device to grip the multi-core shielded cable, and control the other to release the multi-core shielded cable;
control the third gripping device, among the upstream-side third gripping device and the downstream-side third gripping device, corresponding to the first gripping device that has released the multi-core shielded cable to grip the multi-core shielded cable, and control the third gripping device corresponding to the first gripping device that is gripping the multi-core shielded cable to release the multi-core shielded cable; and
further control the first moving device to move the pair of third gripping devices relative to the pair of first gripping devices by the predetermined distance in the orthogonal direction so as to align a position of the upstream tip of the multi-core shielded cable in the orthogonal direction with a position of the downstream tip of the multi-core shielded cable in the orthogonal direction.

9: The processing device for a multi-core shielded cable according to claim 1, wherein:
the first gripping device is provided in the relay device; and
the relay device uses the first gripping device to receive the multi-core shielded cable from the first-step processing device, and hand over the multi-core shielded cable to the second-step processing device.

10: The processing device for a multi-core shielded cable according to claim 9, wherein:
the relay device further includes a second moving device that moves the first gripping device between an upstream-side relay position, at which the multi-core shielded cable is relayed between the first-step processing device and the first gripping device, and a downstream-side relay position, at which the multi-core shielded cable is relayed between the first gripping device and the second-step processing device; and
the controller controls the second moving device to move the first gripping device from the upstream-side relay position to the downstream-side relay position, and drives the first rotating device to move the drain wire to the predetermined position while the first gripping device is moved from the upstream-side relay position to the downstream-side relay position.

11: The processing device for a multi-core shielded cable according to claim 1, wherein the controller controls the first rotating device based on detection by the detection device to rotate the multi-core shielded cable so that the drain wire faces toward the detection device, and then move the drain wire to the predetermined position.
